(19) United States
(12) Patent Application Publication
(10) Pub. No.: US 2013/0332337 A1
(43) Pub. Date: Dec. 12, 2013

(54) Systems and Methods for Enabling Trusted Borrowing and Lending Using Electronic Funds

(71) Applicant: David Nghiem Tran, San Jose, CA (US)

(72) Inventor: David Nghiem Tran, San Jose, CA (US)

(21) Appl. No.: 13/892,250

(22) Filed: May 11, 2013

Related U.S. Application Data
(60) Provisional application No. 61/657,408, filed on Jun. 8, 2012.
(60) Provisional application No. 61/657,692, filed on Jun. 8, 2012.
(60) Provisional application No. 61/722,310, filed on Nov. 5, 2012.

(51) Int. Cl. G06Q 40/02

(52) U.S. Cl. CPC G06Q 40/025
USPC 705/38

(57) ABSTRACT

Methods and systems to enable a borrower to borrow electronic funds from a friend lender include enabling the friend lender to transfer the electronic funds from a digital wallet associated with the friend lender to a digital wallet associated with the borrower.

### CROSS-REFERENCE TO RELATED APPLICATIONS

This application claims the benefit of U.S. Provisional Application No. 61/657,692 filed Jun. 8, 2012 and U.S. Provisional Application No. 61/722,310 filed Nov. 5, 2012.

### BACKGROUND

Banks and financial institutions are the typical sources for borrowing money. Disclosing asset information, employment information, credit information, etc. may not guarantee that a loan application is approved because the banks or financial institutions apply strict guidelines to determine qualification.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 illustrates a block diagram of an example computing device, in accordance with some embodiments.

FIGS. 2A and 2B illustrate some example payment options and scenarios, in accordance with some embodiments.

FIG. 3 illustrates example social networks, in accordance with some embodiments.

FIG. 4A illustrates an example of a borrow-to-pay payment option, in accordance with some embodiments.

FIG. 4B illustrates an example borrow request user interface, in accordance with some embodiments.

FIG. 4C illustrates an example borrow parameter, in accordance with some embodiments.

FIGS. 5A and 5B illustrate example friend lender selections, in accordance with some embodiments.

FIG. 5C illustrates example content of a borrow request, in accordance with some embodiments.

FIG. 5D illustrates an example of lending options, in accordance with some embodiments.

FIG. 5E illustrates example of lending responses, in accordance with some embodiments.

FIG. 5F illustrates example of lending conditions, in accordance with some embodiments.

FIGS. 6A-6E illustrates an example of accounting features, in accordance with some embodiments.

FIG. 7A illustrates an example flow diagram of a borrow process to borrow the electronic funds, in accordance with some embodiments.

FIG. 7B illustrates an example flow diagram of an approval process, in accordance with some embodiments.

FIG. 8 illustrates an example flow diagram of a borrow-to-pay process, in accordance with some embodiments.

FIG. 9 illustrates an example flow diagram of a payment process using a third party borrow facilitator, in accordance with some embodiments.

FIG. 10 illustrates an example flow diagram of a cash-to-electronic funds conversion process using a borrow facilitator, in accordance with some embodiments.

FIG. 11 illustrates an example payment diagram using a borrow facilitator, in accordance with some embodiments.

FIG. 12 illustrates an example block diagram of a borrow facilitator, in accordance with some embodiments.

FIG. 13 illustrates an example network diagram for a network that may be used to implement borrowing electronic funds, in accordance with some embodiments.

FIG. 14 illustrates an example block diagram of a cash-to-electronic funds conversion device, in accordance with some embodiments.

FIG. 15 illustrates an example flow diagram of a cash-to-electronic conversion process using a conversion device, in accordance with some embodiments.

FIG. 16 illustrates an example block diagram for using electronic funds in a digital wallet to fund a mobile wallet, in accordance with some embodiments.

FIG. 17 illustrates an example block diagram for borrowing and transferring electronic funds between a digital wallet and a mobile wallet using a borrow facilitator, in accordance with some embodiments.

### DETAILED DESCRIPTION

For some embodiments, computer-implemented methods and systems for facilitating borrowing and lending transactions using electronic or digital funds are disclosed. The borrowers and lenders involved in the transactions may be related to one another based on a trusted relationship such as friends and family member. The friends and family members may be referred to as friend lenders. Borrow requests may be initiated by the borrowers. The friend lenders may be identified from a group of social network friends. The friend lenders may be identified based on their email addresses or based on their association with the borrower via other online services. A borrow request may be sent to one or more friend lenders. A friend lender may be provided with options to lend or deny the borrow request. Notification may be sent to the borrower about the friend lender's decision. Based on the friend lender agreeing to lend to the borrower, a loan may be created with the electronic funds transferred from a financial account of the friend lender to a financial account of the borrower. Options may be provided to enable the friend lender and the borrower to manage the loan.

For some embodiments, computer-implemented methods and systems for enabling borrowers to borrow electronic funds to complete an online transaction with merchants or service providers. A borrow-to-pay option may be provided on a webpage associated with the merchant or the service provider. Based on the borrow-to-pay option being selected, a borrower may be provided with options to set up a borrow request, identify one or more friend lenders, and cause the borrow request to be sent to the one or more friend lenders. A notification may be generated based on the borrower receiving the electronic funds from a friend lender to enable the borrower to complete the online transaction with the merchants or the service providers.

For some embodiments, computer-implemented methods and systems for converting cash into electronic funds using an intermediary are disclosed. A user having cash may be enabled to initiate a conversion request to convert an amount of cash into an amount of electronic funds. Options may be provided to enable the user to specify an intermediary to receive the conversion request. The intermediary may be a friend or a family member. The intermediary may be a third party commercial service. The intermediary may be provided with an option to agree with the conversion request. The intermediary may be enabled to transfer the amount of electronic funds from a financial account associated with the intermediary to a financial account associated with the user in exchange for receiving the amount of cash from the user.

For some embodiments, a conversion device for converting cash into electronic funds is disclosed. The conversion device may include logic to enable a user to specify a financial account. The conversion device may also include logic to receive an amount of cash from the user, perform a conversion from the amount of cash to an amount of electronic funds, and deposit the amount of electronic funds into the financial account associated with the user. For some embodiments, the conversion device may include logic to enable the user to view online items associated with a merchant and purchase one or more online items using the electronic funds in the financial account.

For some embodiments, a computer readable storage medium having a set of instructions which, if executed by a processor, cause a computer to enable a borrower to initiate a borrow request to borrow electronic funds from one or more friend lenders are disclosed. For some embodiments, a computer readable storage medium having a set of instructions which, if executed by a processor, cause a computer to enable the borrowers to borrow electronic funds to complete an online transaction with a service provider or a merchant are disclosed. For some embodiments, a computer readable storage medium having a set of instructions which, if executed by a processor, cause a computer to enable a user to convert cash into electronic funds using an intermediary are disclosed. For some embodiments, a computer readable storage medium having a set of instructions which, if executed by a processor, cause a computer to convert cash into electronic funds and to enable a user to pay for online items using the electronic funds are disclosed.

In the following description, a borrow facilitator may be used in various examples to describe a system that enables a borrower to set up borrow requests to borrow electronic funds from one or more friend lenders. The borrow facilitator may be associated with a website providing user interfaces to enable the borrower to set up the borrow requests. For some embodiments, the borrow facilitator may be implemented using one or more server computing devices and may be operated as an independent service provider. For some embodiments, the borrow facilitator may be implemented as one of many services provided by a merchant or a service provider. For example, the borrow facilitator may be associated with an online merchant such as Amazon. For another example, the borrow facilitator may be associated with a digital wallet service provider such as PayPal, etc. A borrower may also be a friend lender to someone else. A borrower may use the services of the borrow facilitator by visiting a web site associated with the borrow facilitator directly or based on a redirection from another website.

In the following description, a digital wallet may refer to any application associated with an online account that can be used to make payments when engaging in online or offline transactions with a merchant or a service provider. A digital wallet may be funded using credit cards, debit cards, checking accounts, savings accounts, etc. As will be described, the digital wallet may also be funded with cash and/or by borrowing from one or more friend lenders. A digital wallet may be associated with a cloud-based digital wallet service provider (e.g., PayPal, etc.) and may be accessed via a mobile computing device (e.g., using phone application) or via any computing devices coupled with a network such as the Internet.

In the following description, a mobile wallet may refer to any application that enables storing information associated with credit cards, debit cards, banking information, coupons, rewards, etc. (referred to generally as funding sources) on mobile computing devices. The mobile wallet may enable users of the mobile computing devices to engage in payment transactions with retailers or offline merchants or service providers by choosing any of these funding sources as a method of payment. A mobile wallet service provider may enable its users to access the mobile wallets online and make payments or engage in online transaction with online merchants and service providers.

In the following description, the transfer of electronic funds may refer to an electronic or digital transfer from one financial account to another financial account associated with the same financial institution or with different institutions, through computer-based systems, using any network communication protocol and without involving paper or physical money instruments such as bills, checks, credit cards, coins, etc. The electronic funds may also be referred to as digital money or digital currency. A financial account may be a digital wallet or a mobile wallet.

In the following description, numerous specific details are set forth, such as examples of specific data signals, components, connections, etc. in order to provide a thorough understanding of the present invention. It will be apparent, however, to one skilled in the art that the present invention may be practiced without these specific details. In other instances, well known components or methods have not been described in detail but rather in block diagrams in order to avoid unnecessarily obscuring embodiments of the present invention. Thus, the specific details set forth are merely exemplary. The specific details may be varied from and still be contemplated to be within the spirit and scope of the embodiments of the present invention.

The embodiments of the present invention may also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled with a computing system bus. Portions of any modules or components described herein may be implemented in lines of code in software, configured logic gates in software, or a combination of both, and the portions implemented in software are tangibly stored on a computer readable storage medium.

The algorithms and displays presented herein are not inherently related to any particular computer or other apparatus. Various general purpose systems may be used with programs in accordance with the teachings herein, or it may prove convenient to construct more specialized apparatus to perform the required method blocks. The required structure for a variety of these systems will appear from the description below.

In the following description of exemplary embodiments, reference is made to the accompanying drawings that form a part hereof, and in which it is shown by way of illustration specific embodiments in which the invention can be practiced. It is to be understood that other embodiments can be used and structural changes can be made without departing from the scope of the embodiments of this invention. As used herein, the terms “couple,” “connect,” and “attach” are interchangeable and may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Also, it should be appreciated that one or more structural features described in one embodiment could be implemented in a different embodiment, even if not specifically mentioned as being a feature thereof.

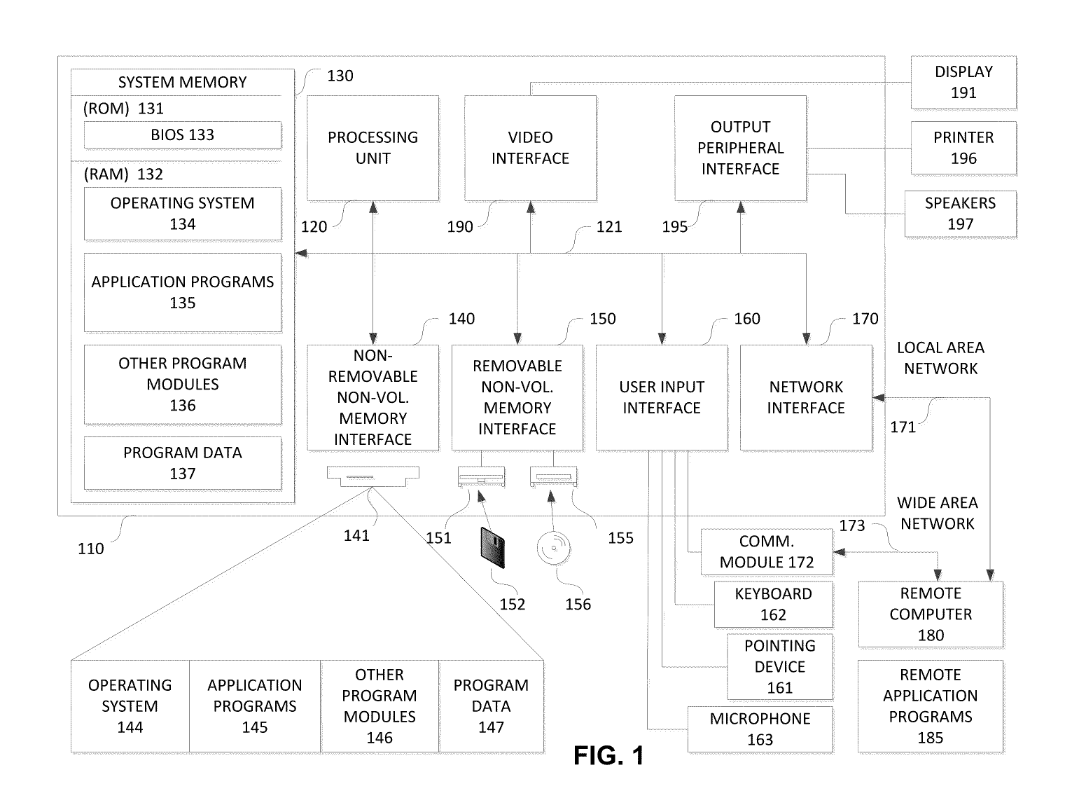

FIG. 1 illustrates a block diagram of an example computing device that may use an embodiment of one or more of the software applications discussed herein. The computing device 110 is only one example of a suitable computing device, such as a client device, and is not intended to suggest any limitation as to the scope of use or functionality of the design. Neither should the computing device 110 be interpreted as having any dependency or requirement relating to any one or combination of components illustrated in FIG. 1.

The design is operational with numerous other general purpose or special purpose computing system environments or configurations. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The design may be described in the general context of computing device executable instructions, such as program modules, being executed by a computing device. Generally, program modules include routines, programs, objects, components, data structures, etc. that performs particular tasks or implement particular abstract data types. Those skilled in the art can implement the description and/or figures herein as computer-executable instructions, which can be embodied on any form of computing device readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing the design includes a general-purpose computing device in the form of a computing device 110. Components of computing device 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing device 110 typically includes a variety of computing device readable media. Computing device readable media can be any available media that can be accessed by computing device 110 and includes both volatile and nonvolatile media, removable and non-removable media. By way of example, and not limitation, computing device readable media may be used to store information, such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 110. Communication media typically embodies computer readable instructions, data structures, program modules, or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computing device 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computing device 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor or display 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing device 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing device 110. The logical connections depicted in FIG. 1 include a local area network (LAN) 171 and a wide area network (WAN) 173, but may also include other networks. Such networking environments are commonplace in offices, enterprise-wide computer networks, intranets and the Internet. A browser application may be resident on the computing device and stored in the memory.

When used in a LAN networking environment, the computing device 110 is connected to the LAN 171 through a network interface or adapter 170. When used in a WAN networking environment, the computing device 110 typically includes a communication module 172 or other means for establishing communications over the WAN 173, such as the Internet. The communication module 172 may be a modem used for wired, wireless communication or both. The communication module 172 may be internal or external, may be connected to the system bus 121 via the user-input interface 160, or other appropriate mechanism. In a networked environment, program modules depicted relative to the computing device 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

For some embodiments, the communication module 172 may be configured to be used for short distance communication. For example, the communication module 172 may include a Near Field Communication (NFC) controller coupled with an antenna to enable short distance communication. For some embodiments, the computing device 110 may also be configured to detect presence of nearby computing devices and identify whether the nearby computing devices are associated with users who may be known to the user of the computing device 110. For example, this may be based on the user id associated with a social network as stored in the computing device 110 and the other computing devices. Alternatively, the detection may be manually triggered by the user of the computing device 110 and the other computing devices.

It should be noted that the present design can be carried out on a computing system such as that described with respect to FIG. 1. However, the present design can be carried out on a server, a computer devoted to message handling, or on a distributed system in which different portions of the present design are carried out on different parts of the distributed computing system.

Another device that may be coupled to bus 111 is a power supply such as a Direct Current (DC) and Alternating Current (AC) adapter circuit. The DC power supply may be a battery, a fuel cell, or similar DC power source that needs to be recharged on a periodic basis. For wireless communication, the communication module 172 may employ a Wireless Application Protocol to establish a wireless communication channel. The communication module 172 may implement a wireless networking standard such as Institute of Electrical and Electronics Engineers (IEEE) 802.11 standard, IEEE std. 802.11-1999, published by IEEE in 1999.

While other systems may use, in an independent manner, various components that may be used in the design, a comprehensive, integrated system that addresses the multiple advertising system points of vulnerability described herein does not exist. Examples of mobile computing devices may be a laptop computer, a cell phone, a personal digital assistant, or other similar device with on board processing power and wireless communications ability that is powered by a DC power source that supplies DC voltage to the mobile device and that is solely within the mobile computing device and needs to be recharged on a periodic basis, such as a fuel cell or a battery.

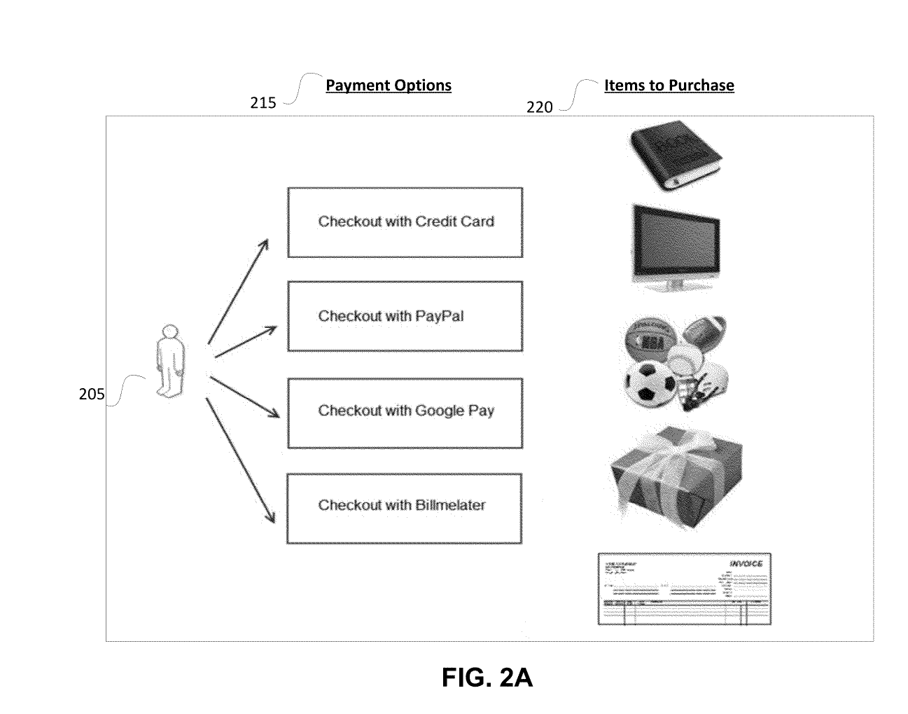

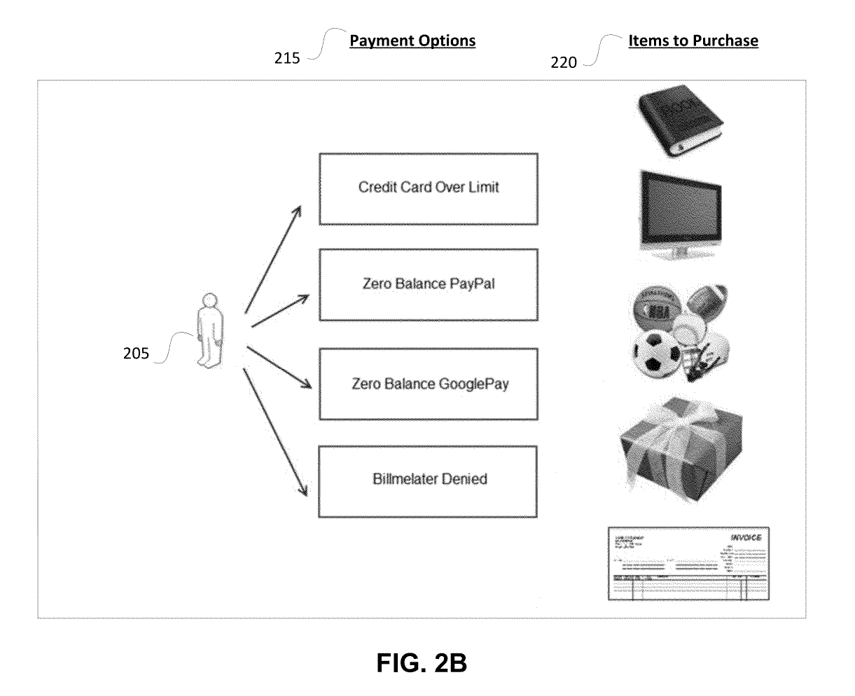

Turning to FIG. 2A, example payment options are shown. A user 205 may use a computing device 110 to connect to a web site of a service provider or an online merchant to engage in online transactions. The online transaction may involve purchasing an item, paying a bill or an invoice, giving a donation, etc. The user 205 may purchase an item 220 by adding it to an online shopping cart and proceeding to a checkout page. The user 205 may be presented with a list of possible payment options 215 which may include paying by credit card, paying using a digital wallet, paying by using a checking account or savings account, and paying by getting a credit line via the service of a bank or a bank partner (e.g., BillMeLater).

Turning to FIG. 2B, example payment rejections are shown. The user 205 in the example may not be able to complete the payment process due to not having sufficient funds. This may be due to the lack of having a credit card, having insufficient credit card balance, having poor credit rating, etc. Typically, when the user 205 is unable to use any of the available payment options 215, the online transaction cannot be completed and must be abandoned or canceled. This may not be a desirable situation for both the user 205 and the merchants or service provider.

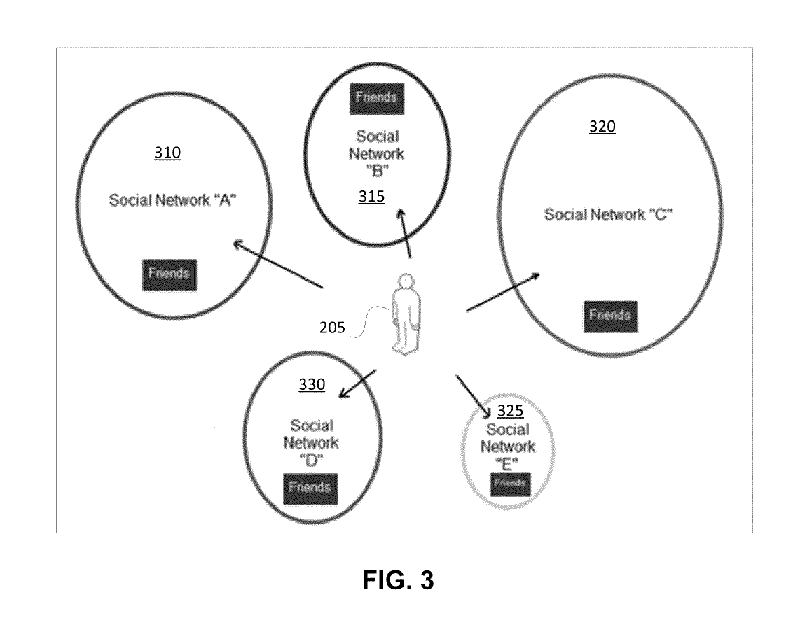

Turning now to FIG. 3, example social networks are shown. The user 205 may be a member of social networks 310-330. For example, the social network 310 may be Facebook, the social network 315 may be MySpace, the social network 320 may be Yelp, etc. Other social networks may include Google+, Twitter, etc. Each of the social networks 310-330 may include a “friend” (e.g., “best friend”, “close family members”, etc.) or “follower” feature which may enable the user 205 to have a special connection with selected members of the appropriate social network. The special connection may enable the user 205 to engage in various conversations with each of the friends and followers (referred to herein generically simply as “friends”). The special connection may also enable the user 205 to access information of the friends that may not be accessible by other members of the same social network.

For some embodiments, the user 205 may initiate borrow requests to borrow electronic funds from one or more of these social network friends. The electronic funds may be used to complete the online transaction described in FIG. 2B. As mentioned, the user 205 may be referred to as a borrower when associated with setting up a borrow request.

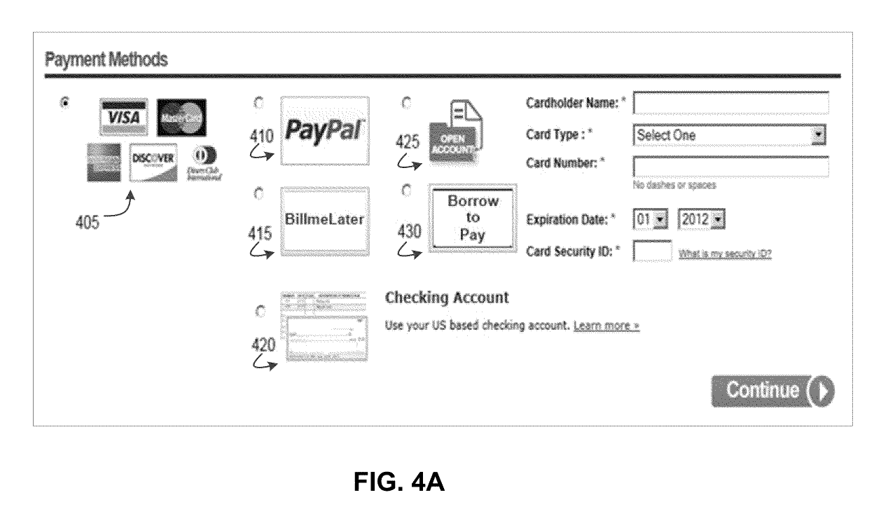

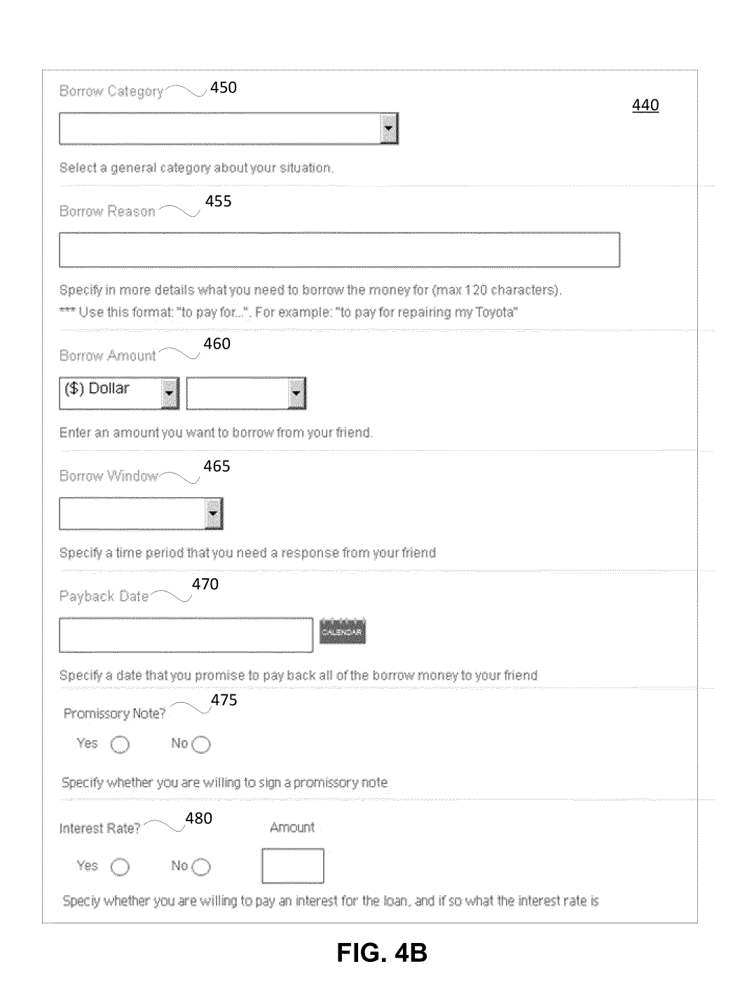

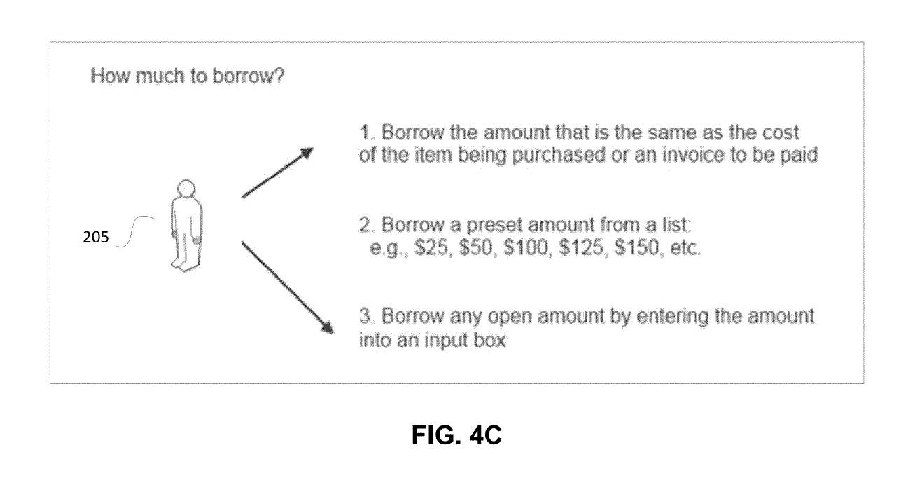

Turning to FIG. 4A, an example of a borrow-to-pay payment option is shown. The borrow-to-pay payment option 430 may be presented to the user/borrower 205 along with other payment options such as, for example, credit card payment option 405, PayPal payment option 410, BillMeLater payment option 415, checking account payment option 420, open-a-new-account option 425. For some embodiments, when the borrower 205 selects the borrow-to-pay option 430, the borrower 205 may be redirected to a website associated with a borrow facilitator to set up a borrow request to borrow the electronic funds from one or more friends (referred to as friend lenders).

Turning to FIG. 4B, an example borrow request user interface is shown. The borrow request user interface 440 may include options to enable the borrower 205 to specify various borrow parameters including one or more of a borrow category 450, a borrow reason 455, a borrow amount 460, a borrow window 465 and a payback date 470. The borrow window 465 may be used to enable the borrower 205 to let a friend lender know a how soon the borrower 205 needs a decision from the friend lender. For some embodiments, the borrow parameters in a borrow request to borrow electronic funds may include at least the borrow amount 460 and the payback date 470. FIG. 4B also illustrates some examples of borrow conditions including promissory note requirement 475 and an interest rate requirement 480. For some embodiments, a borrower may voluntarily agree to certain borrow conditions and may include them in the borrow request. For some embodiments, certain borrow conditions may be requested by the friend lender to lend the electronic funds.

As shown in FIG. 4C, the borrow amount 460 may be specified based on a price of an item (e.g., a laptop) that the borrower 205 is trying to purchase from an online merchant or based on an expense (e.g., a utility bill) that the borrower 205 is trying to pay to a service provider. The borrow amount may also be selected from a list of preset amounts, or it may be manually entered by the borrower 205. For some embodiments, options may be available to enable the borrower 205 to pre-set and save one or more of the borrow parameters so that they may be applied to all new borrow requests. For example, the borrower 205 may decide not to sign any promissory note or pay any interest. The borrower 205 may also elect to keep the borrow window 465 the same for all new borrow requests. By pre-setting one or more of the borrow parameters, it may be faster and simpler for the borrower 205 to set up new borrow requests. The pre-set values may be saved with the user profile information associated with the borrower 205. This may be convenient because the number of steps required to set up a borrow request may be reduced to a minimum. For example, the borrower may be able to send an express borrow request using a smart phone by opening an application associated with the borrow facilitator and providing a borrow amount and identification of a friend lender. For some embodiments, instead of using the pre-set values, a simple borrow request may be formed by just providing a borrow amount and an identification of a friend lender.

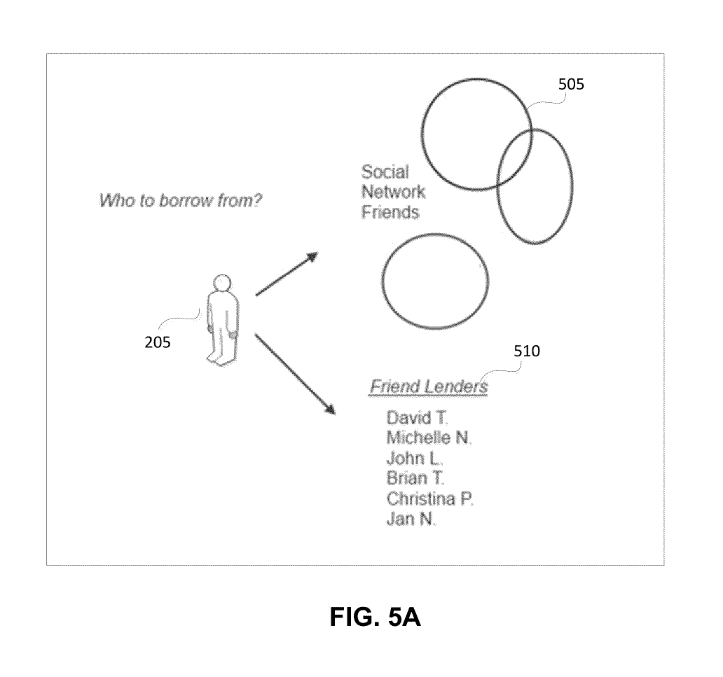

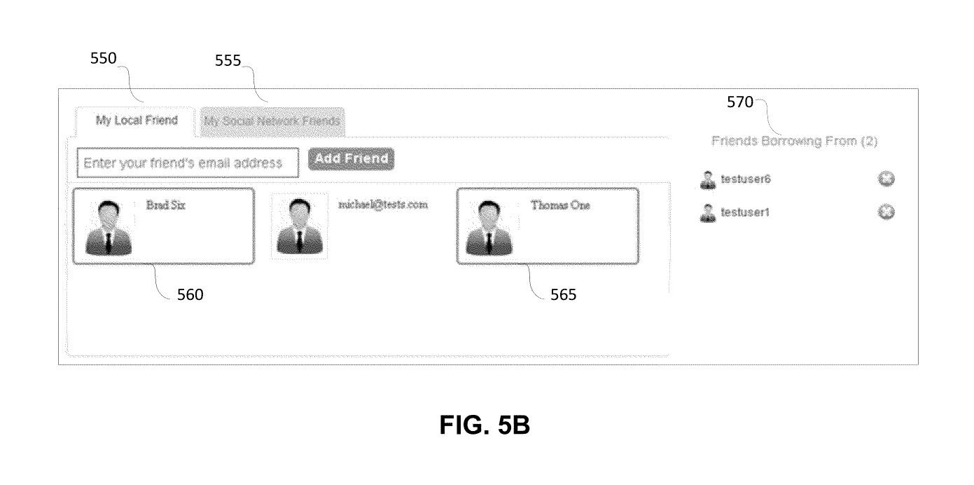

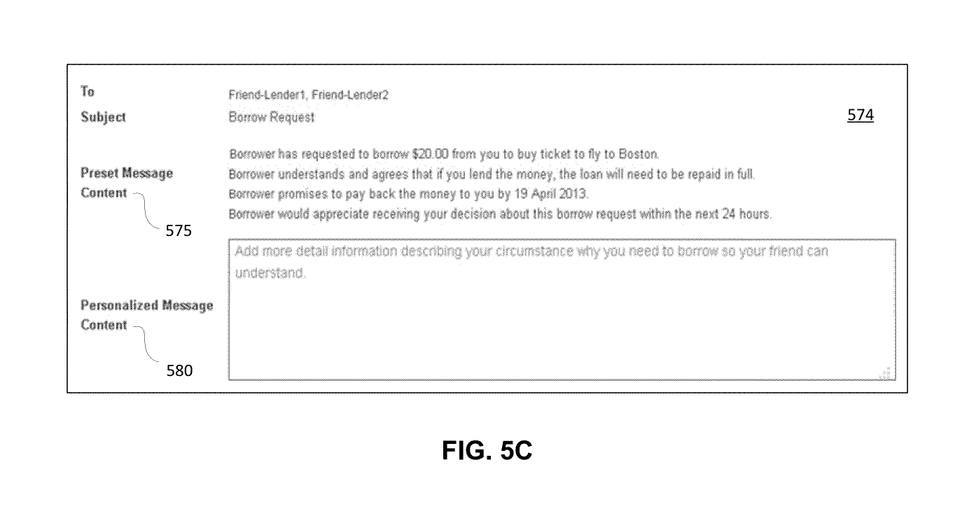

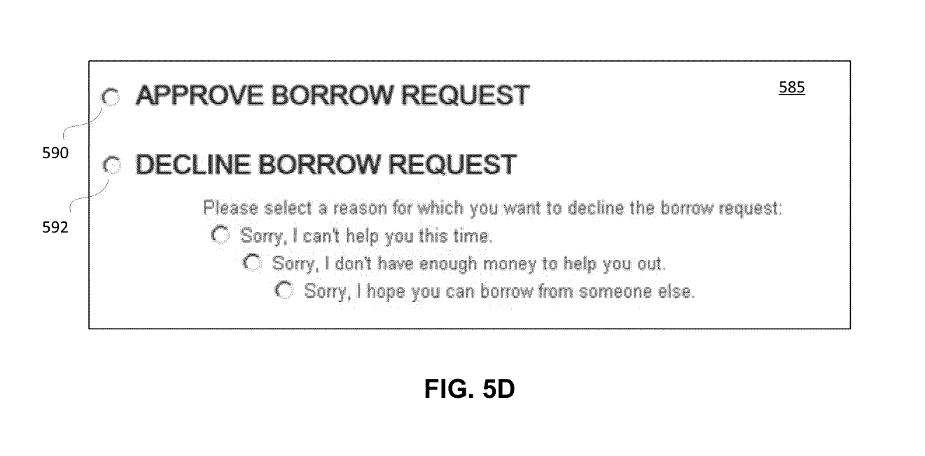

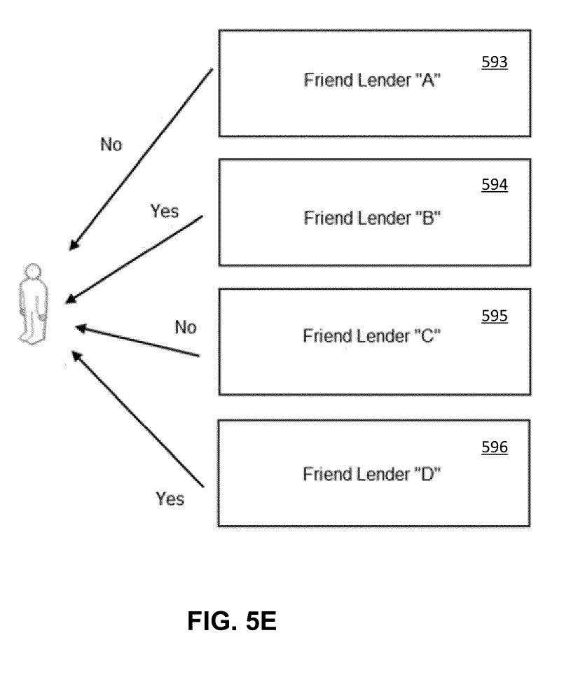

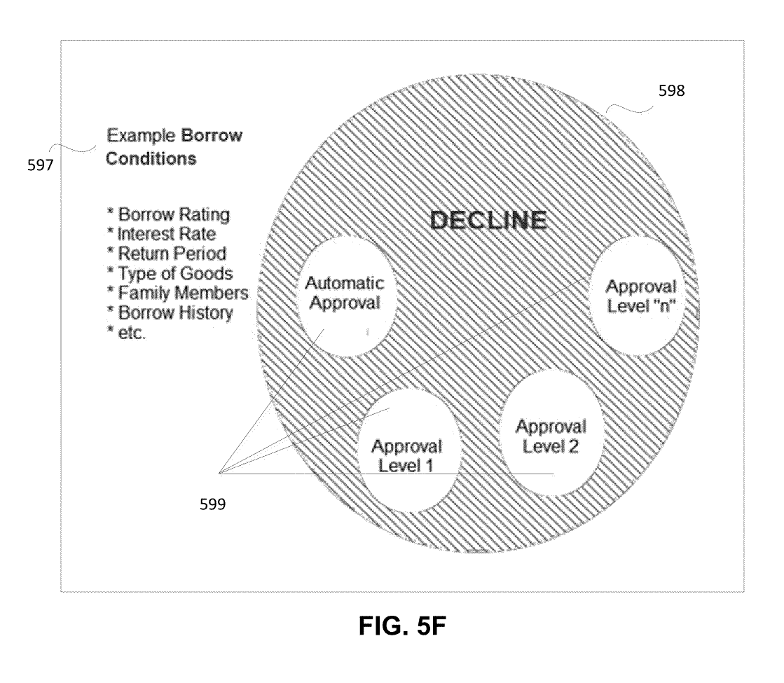

Turning to FIG. 5A, example friend lenders are shown. Friend lenders may include friends and family members who may be able to lend electronic or digital funds to the borrower 205. The friend lenders may be members of the various social networks 505 and may have been set up as having a special connection to the borrower 205 in those social networks. For some embodiments, the friend lenders may also include those outside of the social networks 505. For example, the information about the friend lenders 510 may be retrieved from email contact lists of the borrower 205, or they may be specified manually by the borrower 205. It may be noted that the friend lenders are different from the people (e.g., professional investors) or entities (e.g., financial institutions) that provide and perform lending services as a business. The friend lenders may be those who happen to have sufficient electronic funds to lend to the borrower 205 based on a trusted relationship. It is this trusted relationship that enables the friend lenders to make the lending decision with flexible payment terms (e.g., interest rate, payment schedule, promissory note, etc.) appropriate for the situation.

For some embodiments, the borrower 205 may be able to borrow the electronic funds from a financial institution or a professional investor based on the financial institution or the professional investor being a social network friend of the borrower 205. In this situation, the financial institution or the professional investor may make the lending decision based on a trusted relationship with the borrower 205.

For some embodiments, when a lending decision is made based on the trusted relationship, it may not be necessary for the borrower 205 to fill out a traditional loan application that requires disclosing asset information, employment information and debt or liability information. For some embodiments, an option may be available for the friend lender to waive the requirement for a promissory note. For some embodiments, an option may be available for a friend lender to waive any interest. For some embodiment, a repayment schedule may vary based on the ability of the borrower 205 to make a payment.

Turning to FIG. 5B, example of selection of multiple friend lenders are shown. It may be possible for the borrower 205 to select multiple friend lenders from different sources to receive the same borrow request. For example, the borrower 205 may select a first friend lender 560 from a local group of friends 550 and a second friend lender 565 from a group of social network friends 555. In the example, the selected friend lenders 560 and 565 may also be displayed together as group 570.

For some embodiment, options may be available to enable the borrower 205 to pre-set and save a set of one or more friend lenders that the borrower 205 wants to borrow from for all new borrow requests until modified. For example, the borrower 205 may elect to only borrow from immediate family members and set up a group of friend lenders that only include parents, sisters and brothers. The borrower 205 may also be enabled to set up multiple groups of friend lenders for any new borrow requests. For example, there may be a group of immediate family members, and there may be a group of closest friends.

As mentioned in FIG. 1, the computing device 110 may be configured to detect presence of nearby computing devices and identify whether the nearby computing devices are associated with friends. The computing device 110 may be a mobile computing device (e.g., a smart phone), and the location information may be provided by a global positioning system (GPS) feature configured in the computing device 110 and in the computing device associated with the friends. For some embodiments, the computing device 110 may be configured to use information about the borrower's social network friends, compare that with the presence information that it detects, determine whether any of the borrower's friends happen to be nearby, and present the result to the borrower. For example, the information about the nearby friends may be presented using the interface shown in FIG. 5B under a category of nearby friend lenders. The borrower 205 may then have the option to select a nearby friend lender to receive the borrow request.

For some embodiments, options may be available to enable a friend lender to automatically approve a borrow request received from a particular borrower. For example, the friend lender may be a parent. With the automatic approval, the friend lender may set up the financial account to transfer the borrow amount to the financial account of the borrower automatically. This may save the friend lender from having to manually log into the financial account and perform the transfer of the borrow amount. It should be noted in these embodiments that, even though the lending may be pre-approved, the process normally starts with a borrow request and the borrower has an expectation to repay the borrow amount. It should be noted that the pre-approval lending is based on trust and not based on previously filing a loan application. This is different from having a credit line where the borrower previously filled out a loan application to qualify. With pre-approval lending based on trust, the decision time by the friend lender may be removed resulting in a virtually immediate availability of electronic funds to the borrower. As a result, when the borrowing is for the purpose of purchasing an online item or paying an online invoice, the completion of the checkout process may occur fairly quickly.

Turning to FIG. 5C, example of content of a borrow request is shown. For some embodiments, the borrow request 574 may include a preset content 575 and a personalized content 580. The preset content 575 may be based on the borrow parameters provided by the borrower 205. For some embodiments, the preset content 575 may also include a confirmation that the borrower 205 understands that the loan need to be repaid. The personalized content 580 may be used by the borrower 205 to add any information not already conveyed by the borrow parameters and the preset content 575. It may be noted that the borrow request 574 in this example is shown as an email. For some embodiments, the borrow request may be posted on a wall (or timeline) of a social network associated with a friend lender.

For some embodiments, when the borrow requests is initiated from a site of an online merchant (e.g., using the borrow-to-pay option 430 shown in FIG. 4A), the purchase of the item may be delayed. For example, the purchase of the item may be electronically and temporarily delayed, placed on hold or lay away. This may give the borrower 205 the necessary time to wait for the friend lender to review the borrow request and to transfer the necessary electronic funds. When the borrower 205 receives the electronic funds in the financial account, the purchase of the item may be continued. It may be noted that there may not be any limit to the borrow amount based on the trusted relationship as long as both the borrower 205 and the friend lender agree. For example, a borrower may send a borrow request to borrow electronic funds to buy a book or to use as a down payment for a house.

Turning to FIG. 5D, an example of lending options is shown. For some embodiments, when a friend lender receives the borrow request 574, the friend lender may be presented with the lending options 585 to approve or decline the borrow request. For example, when the friend lender selects the approval option 590, the friend lender may be presented with options to log into the financial account of the friend lender and cause the borrow amount to be transferred to the financial account of the borrower. For some embodiments, when the friend lender selects a decline option, one or more preset decline options may be presented. For example, when the decline option 592 is selected, three preset options with different decline messages may be displayed to be selected by the friend lender.

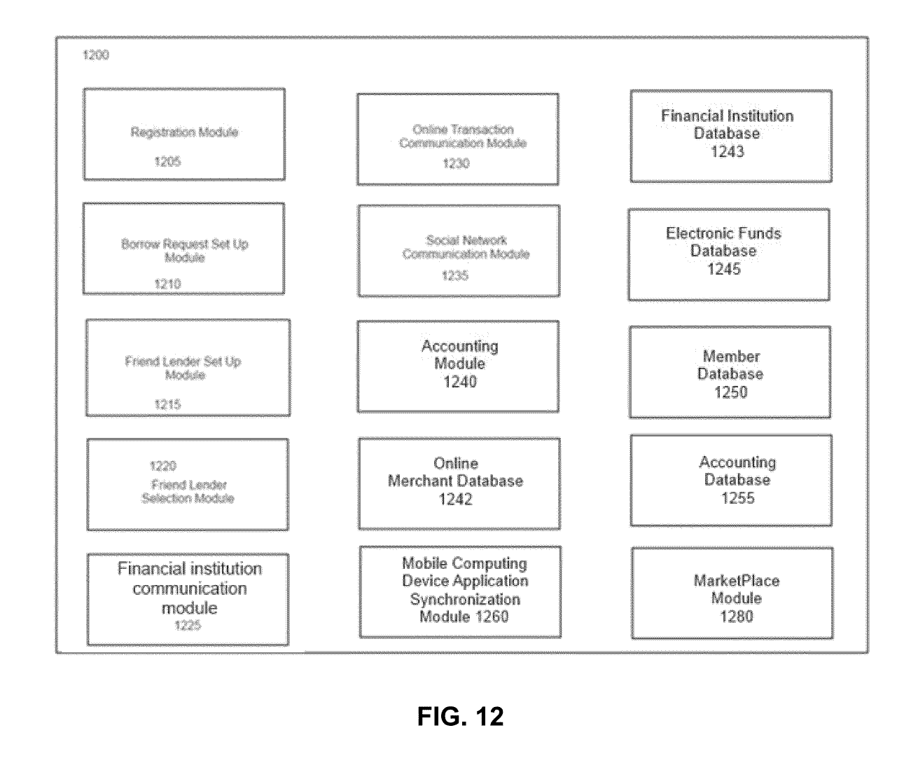

Turning to FIG. 5E, an example of lending responses is shown. For some embodiments, in order to be able to send a borrow request, a user may be required to provide information about a financial account (e.g., a digital wallet). The information about the financial account may be stored in a database (e.g., database 1243 shown in FIG. 12) and may be used to receive the electronic funds that the user is trying to borrow. It may be noted that the requirement to specify an existing financial account to receive the electronic funds is uniquely different from getting a loan with the banks or financial institutions. When a user sends a borrow request to multiple friend lenders, it may be possible that the user may receive zero or more lending approval (or positive responses) and zero or more declines (or negative responses). For some embodiments, the user may be enabled to get the borrow amount cumulatively from multiple friend lenders. For example, the user may send out a borrow request to four friend lenders 593-596 to borrow $20.00. The friend lenders 593 and 595 may decline the borrow request, while the friend lenders 695 and 596 may approve the borrow request. The user may decide to borrow only from the friend lender 594, only from the friend lender 596, or some from each of the friend lenders 594 and 596. For some embodiments, when there are multiple friend lenders approving the borrow request, the user may be enabled to borrow from the multiple friend lenders even though the cumulative borrow amount may be larger than the original borrow amount. For example, the user may decide to borrow $20.00 from the friend lender 594 and $20.00 from the friend lender 596. For some embodiments, when there are multiple friend lenders approving the borrow request, the user may be enabled to borrow from the multiple friend lenders but the cumulative amount may not be larger than the original borrow amount. For example, the user may decide to borrow $8.00 from the friend lender 594 and $12.00 from the friend lender 596. For some embodiments, a friend lender may approve a borrow request but with condition (e.g., smaller borrow amount, interest rate, payback date, etc.). In these situations, the user may be enable to select the friend lenders who provide the most favorable terms in order to get the borrow amount. For example, the user may be enabled to borrow $15.00 from the friend lender 594 and $5.00 from the friend lender 596 because the friend lender 594 can only lend a maximum of $15.00 at zero interest rate while the friend lender 596 can lend $20.00 but at 3% interest rate. For some embodiments, when an approval is provided by one friend lender for a full borrow amount, the borrow request may be considered closed to the other friend lenders. For some embodiments, the approval of a borrow request may be implied when a friend lender selects an option to lend the electronic funds to the borrower. In this situation, it may not be necessary for the borrower to have to select an approving friend lender since the first approving friend lender may be redirected to a service to enable the transfer of the electronic funds.

Turning to FIG. 5F, examples of borrow conditions are shown. For some embodiments, there may be different borrow conditions 597 that may be associated with a borrow request. A friend lender may have conditions before approving a borrow request. The borrow conditions may include a borrow rating of the borrower, an interest rate associated with the borrow request, payment period, borrow purpose or reason, type of goods being purchased with the borrow amount, whether the borrower is a family member, the borrow history of the borrower, etc. The borrow rating may be based on how the borrower conducted on past loans such as timely payment, feedbacks from previous or current friend lenders, etc. The borrow history may be based on how often the borrower borrows and the size of the past borrow amounts. For some embodiments, the borrow conditions may also include a consumer credit rating as provided by one or more credit reporting companies. For some embodiments, a borrower may voluntarily agree one or more borrow conditions when setting up the borrow request. For example, the borrower may agree to allow the consumer credit rating information and the borrow history to be released to the friend lender to enable the friend lender to decide whether to lend the electronic funds. It may be noted that the borrower has control over which borrow condition is agreed to. For example, the borrower may indicate in the borrow request that the borrower is willing to provide a promissory note to the friend lender. For some embodiments, the friend lender may have to accept the borrow conditions proposed by the borrower without imposing other borrow conditions. For some embodiments, the friend lender may modify the terms of the borrow conditions proposed by the borrower. Thus, if a friend lender does not like the borrow condition offered by the borrower, the friend lender may decline the borrow request or may modify a borrow condition proposed by the borrower. For example, the borrower may indicate in the borrow request that the borrower is willing to pay 2% interest rate for the loan, and the friend lender may modify that interest rate to 2.5%. As another example, a friend lender may agree to lend the electronic funds but with the condition that the loan is repaid within one week even though the borrower may have proposed a different payment period in the borrow request. For some embodiments, when a friend lender agrees to lend the electronic funds with a modified term of a borrow condition, the borrower is provided an opportunity to accept or to reject the loan from the friend lender. Note that this is different from the traditional loan application where the lender demands the borrower to comply with the borrow conditions (e.g., provide employment information, credit rating information, asset and liability information, etc.) before the borrow request is reviewed or considered. Circular shape 598 illustrates an example of all the responses that a borrower receives from the friend lenders. These responses may include declines and approvals 599. The approvals may include automatic approvals and approval with zero or more borrow conditions.

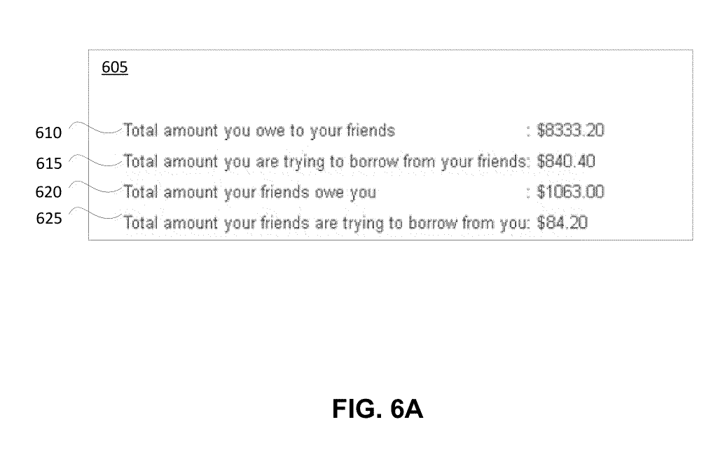

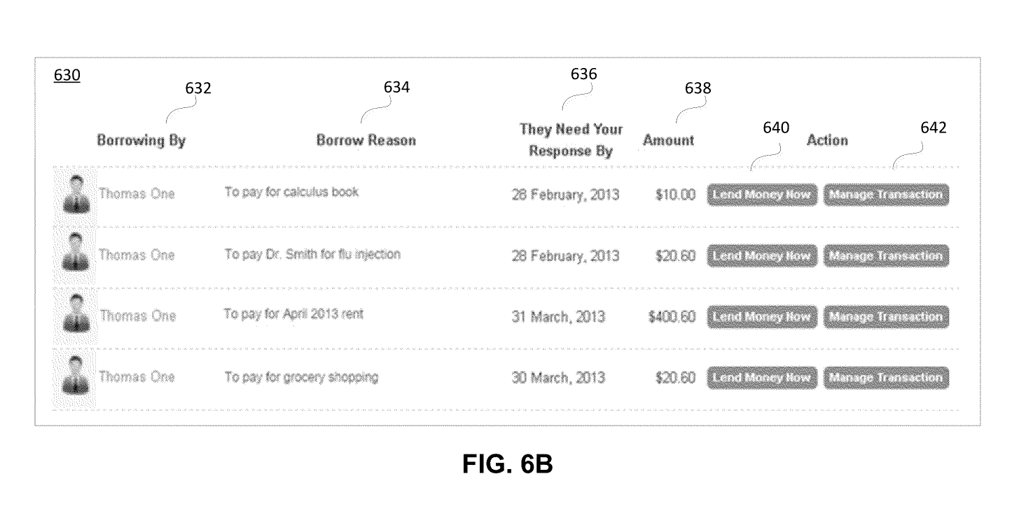

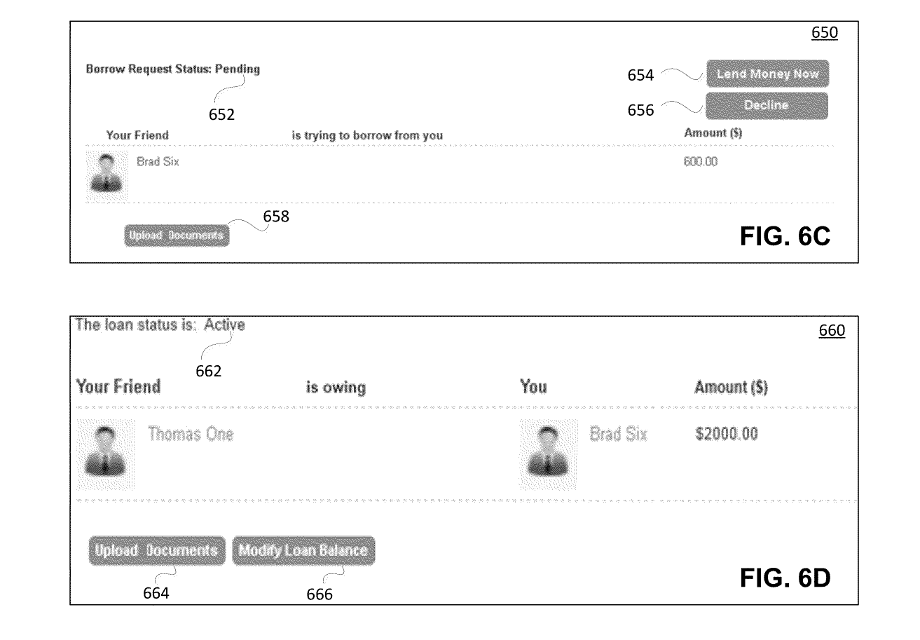

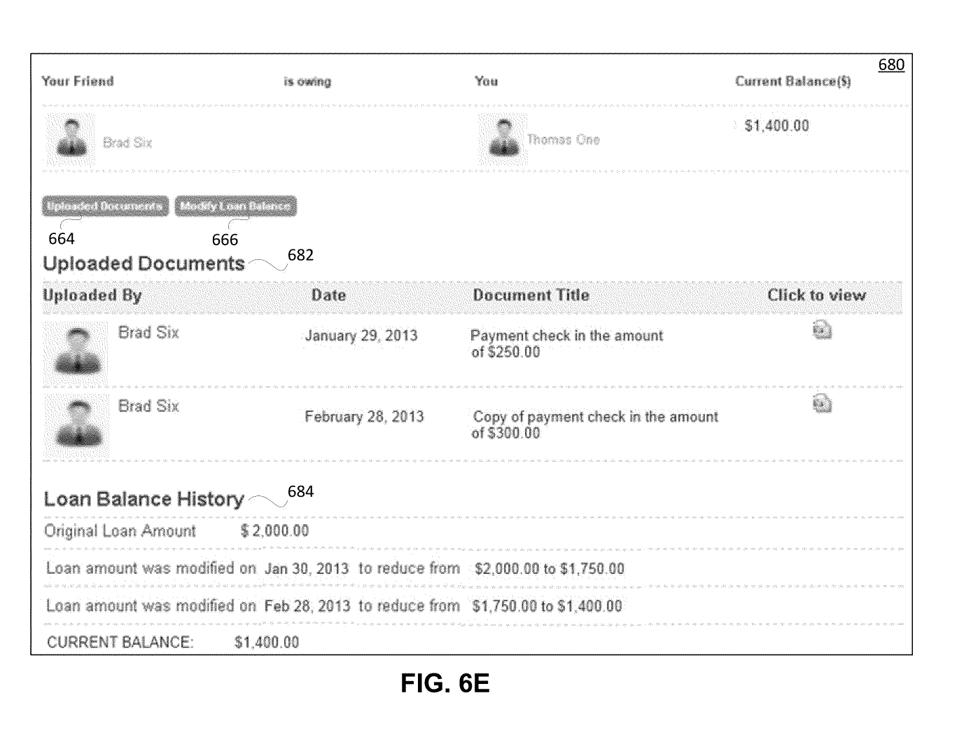

Turning to FIG. 6A, an example of borrowing and lending summaries is shown. As mentioned, a user may be both a borrower in some transactions and a lender in some other transactions. The summary 605 may include owing information 610 (e.g., the user owing to the friend lenders), trying-to-borrow information 610 (e.g., the user trying to borrow from the friend lenders), owed information 615 (e.g., friends owing the user), and friend-trying-to-borrow information 620 (e.g., friends trying to borrow from the user).

Turning to FIG. 6B, an example user interface showing friends trying to borrow information is shown. The user interface of friends trying to borrow information 600 may include information about the friends 632 who sent the borrow requests, the borrow reason 634, the borrow window 636 and the borrow amount 638. There may be options to enable a user to perform actions to process the borrow requests. This may include the lend money action 640 and the manage transaction action 642. The lend money action 640 may enable the user to log into the financial account and lend electronic or digital funds to the friends who sent the associated borrow request. The manage transaction action 642 may enable the user to perform additional operations related to the pending borrow request.

Turning to FIG. 6C, an example user interface of a pending borrow request is shown. The user interface of a pending borrow request 650 may include the pending status information 652, the lend money option 654, the decline option 656 and the upload document option 658. The lend money option 654 may operate similar to the lend money option 640 in FIG. 6B. The decline option 656 may operate similar to the decline option 595 shown in FIG. 5D. The upload document option 658 may enable a borrower or a friend lender to upload documents that may be related to the borrow request. For example, a friend lender may upload a promissory note that the friend lender wants the borrower to sign before agreeing to lend the electronic funds. For another example, a borrower may upload a document containing information about an item that the borrower is using as a security for the loan, or an item that the borrower is willing to exchange for the amount being requested, or an item that the borrower is offering to the friend lender to reduce a loan balance of an active loan.

Turning to FIG. 6D, an example user interface of an active loan transaction is shown. The user interface of an active loan transaction 660 may include the active loan status information 662, the upload document option 664, and the modify loan balance option 666. When there is a loan of electronic funds between a user and a friend lender, different loan status may be shown to reflect the current balance of the loan. For example, the status may be “active” to reflect a positive balance or “closed” to reflect a zero balance. The upload document option 654 may operate similar to the upload document option 658 of FIG. 6C. For some embodiments, the uploaded documents may only be replaced or deleted by same user that uploaded the documents. The modify loan balance option 666 may enable modifying the loan balance to a different amount. For some embodiments, only the lender in an active loan transaction (i.e., with positive loan amount) may change the loan balance. For some embodiments, the loan amount may only be decreased and not increased by the lender. For some embodiments, based on a need to increase an active loan by a certain amount, a new borrow request may need to be generated for the same amount. FIG. 6E shows an example user interface of an active loan transaction that includes upload document information and loan balance modification information. The user interface 680 may include detail information about the documents 682 including, for example, the author of the documents, the upload date and the title of the documents. The user interface 680 may also include detail information about the loan balance history 684 including, for example, the original loan balance information, the loan balance modification date and the loan balance modified amount, and the current loan balance information.

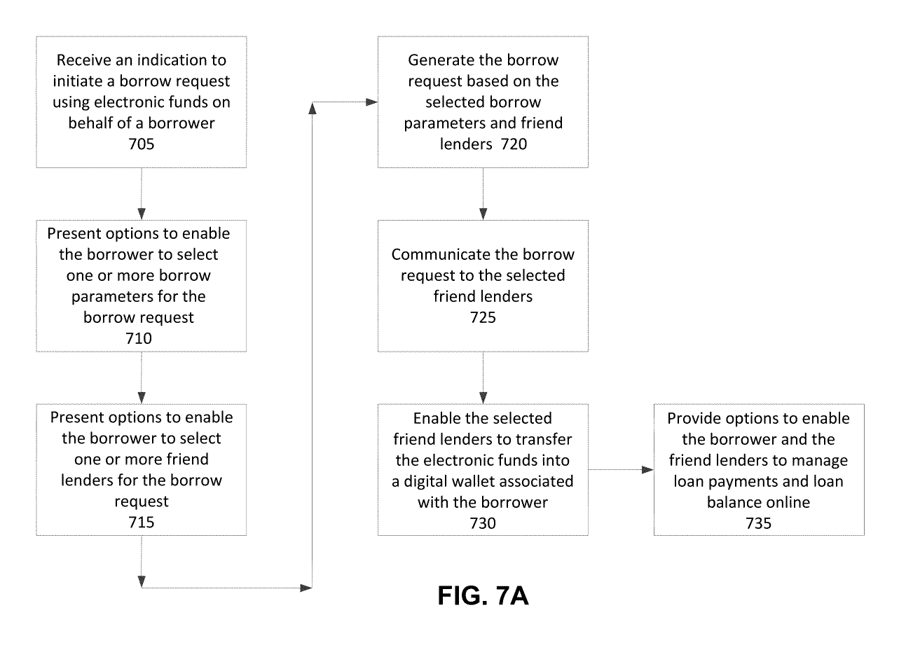

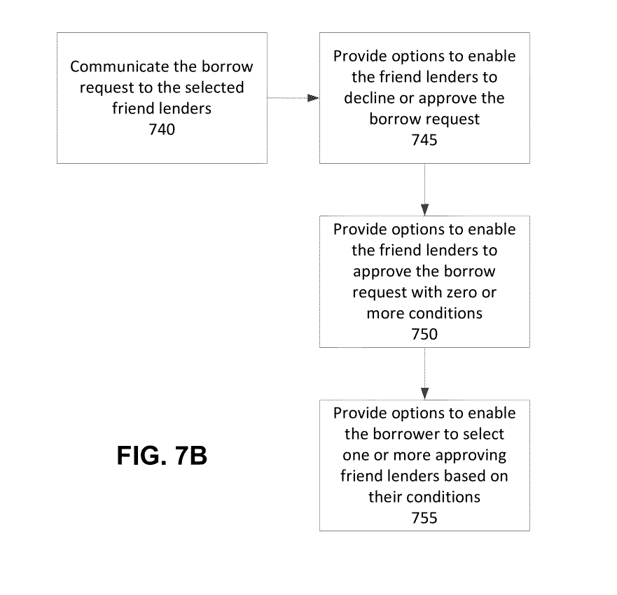

Turning to FIG. 7A, an example flow diagram of a borrow process is shown. The borrow process may begin at block 705 based on receiving an indication to initiate a borrow request. The borrow request may be associated with a borrower. For example, a borrower may log into a website associated with a borrow facilitator and select an option to initiate a borrow request.

At block 710, borrow parameters may be presented to enable the borrower to form the borrow request. Borrow parameter example are shown in FIG. 4B. A borrow amount may be specified via a user interface associated with the website. The borrower may select a preset borrow amount from a list of available borrow amounts (e.g., $50, $100, $150, etc.). Alternatively, the borrower may use free form to specify any amount (e.g., $34.15) by entering the borrow amount into an input area.

At block 715, options may be presented to enable the borrower to select the friend lenders to receive the borrow request. Examples of types of friend lenders are shown in FIGS. 5A and 5B.

At block 720, the borrow facilitator may generate the borrow request based on the borrow parameters and the selected friend lenders. For some embodiments, the borrow request may be formed using a preset format. For some embodiments, the borrow request may be formed using a combination of the preset format and a free-form format. For example, the borrower may use the free-form format to add personalized content to the borrow request. An example of the preset format and the free-form format is shown in FIG. 5C.

At block 725, the borrow request may be communicated to the one or more friend lenders selected by the borrower. For some embodiments, the borrow request may be communicated via a social network or via an email system. For some embodiments, the borrow request may be communicated via a messaging system (or text messages) or via telephone using voice communication. For some embodiments, a combination of two or more of the above communication methods may be used.

At block 730, options may be presented to enable the one or more friend lenders to transfer the electronic funds from their financial accounts into the financial accounts of the borrower. For example, based on a friend lender approving a borrow request, the friend lender may be redirected to a website of a digital wallet service provider (e.g., PayPal). The redirection may include at least information about the borrow amount and information about the borrower's digital wallet. The friend lender may then login to the website of the digital wallet service provider, access own digital wallet and causing the transfer of the borrow amount into the borrower's digital wallet. It may be noted that the digital wallet of the friend lender and the digital wallet of the borrower may be associated with the same digital wallet service provider or with different digital wallet service providers. At block 735, the borrow facilitator may provide accounting options to enable the borrower and the lender to manage the borrow requests and the active loans of the electronic funds. Examples of the accounting options are shown in FIGS. 6A-6E. It should be noted that, depending on the implementation, one or more of the operation blocks described in this process may not be necessary or may be combined with other operation blocks. Further, the order of the operation blocks may be rearranged to accommodate the different implementations.

Turning to FIG. 7B, an example flow diagram of an approving process is shown. The approving process may begin at block 740 based on a borrower causing a borrow request to be generated. The borrow request is then communicated to a friend lender. The communication may be performed by the borrow facilitator and may be by emails, text messages, voice calls, posting a private message using the communication tool of the social network (e.g., Facebook wall or timeline), or a combination of these. The communication with the friend lenders may include information about the borrower, the borrow amount, and other borrow parameters

At block 745, options to enable the friend lender to approve or decline the borrow request may be presented along with the borrow request. An example is shown in FIG. 5D. For some embodiments, there may be a default time limit when the borrow request sent to a friend lender may expire. For example, if a friend lender fails to respond to a borrow request within 24 hours, the borrow request may be considered canceled. For some embodiments, the borrower may specify a specific duration that a borrow request period may remain valid. The borrow request period may be included as part of the borrow request sent to the friend lenders.

At block 750, options to enable the friend lender to modify any borrow conditions may be presented. Depending on the borrow condition proposed by the borrower with the borrow request, the friend lender may decide to proceed with the proposed condition or with a modified condition.

At block 755, options may be presented to the borrower to select or decline an approving friend lender with the modified condition. For example, the borrower may prefer to borrow from a friend lender who has a more lenient borrow condition over a friend lender who has a more stringent borrow condition.

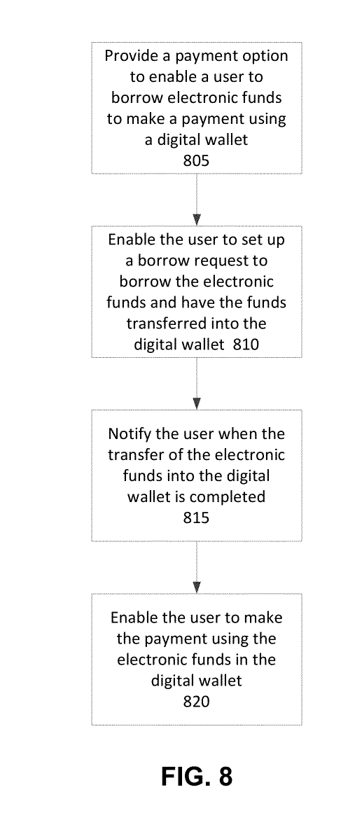

Turning to FIG. 8, an example flow diagram of a payment process is shown. The payment process may be performed based on a borrower trying to complete a transaction using the electronic funds. The transaction may be an online transaction with a merchant or a service provider.

At block 805, a payment option that enables a borrower to borrow electronic funds to complete a transaction is presented. An example of a borrow-to-pay payment option is shown in FIG. 4A. The borrow-to-pay payment option may enable the borrower to borrow electronic funds from one or more friend lenders. At block 810, options may be presented to enable the borrower to set up a borrow request to borrow the electronic funds. For some embodiments, the borrow amount may be the same as the amount needed to pay the merchant or the service provider. The borrower may have options to borrow an amount different than the amount needed to pay the merchant or the service provider. The electronic funds may be transferred from a digital wallet of a friend lender to a digital wallet of the borrower. At block 815, the borrower may be notified based on completion of the transfer of the electronic funds in the digital wallet of the borrower. The notification may be via email message, text message, social network posting, automatic voice call, etc. At block 820, the borrower may be enabled to resume or continue the transaction with the merchant or the service provider. For some embodiments, the operations described in blocks 810 and 815 may be performed by a third party borrow facilitator.

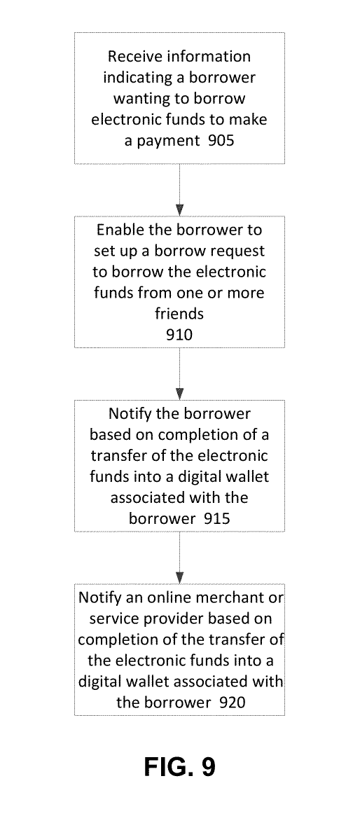

Turning to FIG. 9, an example flow diagram of a payment process using a third party borrow facilitator is shown. The payment process may be based on a borrower trying to complete a transaction using electronic funds. The transaction may be an online transaction with a merchant or a service provider. The process may begin at block 905 based on receiving information indicating a borrower wanting to borrow electronic funds. The information may be communicated by a merchant or service provider via a network. For example, an application programming interface (API) may be used to redirect the borrower from a website of the merchant or the service provider to a website associated with the third party borrow facilitator. Information associated with the online merchant or service provider may be passed as parameters via the API. At block 910, options may be presented to the borrower to enable the borrower to set up a borrow request to borrow the electronic funds from one or more friends. For some embodiments, the parameters may be used by the borrow facilitator to remind the borrower about the transaction with the online merchant or service provider. For example, the borrow facilitator may enable the borrower to set up a borrow request and send the borrow request to one or more friend lenders, as described in FIG. 7A. At block 915, the borrower may be notified based on completion of a transfer of the electronic funds into a digital wallet associated with the borrower. At block 920, an online merchant or service provider may be notified based on completion of the transfer of the electronic funds into a digital wallet associated with the borrower.

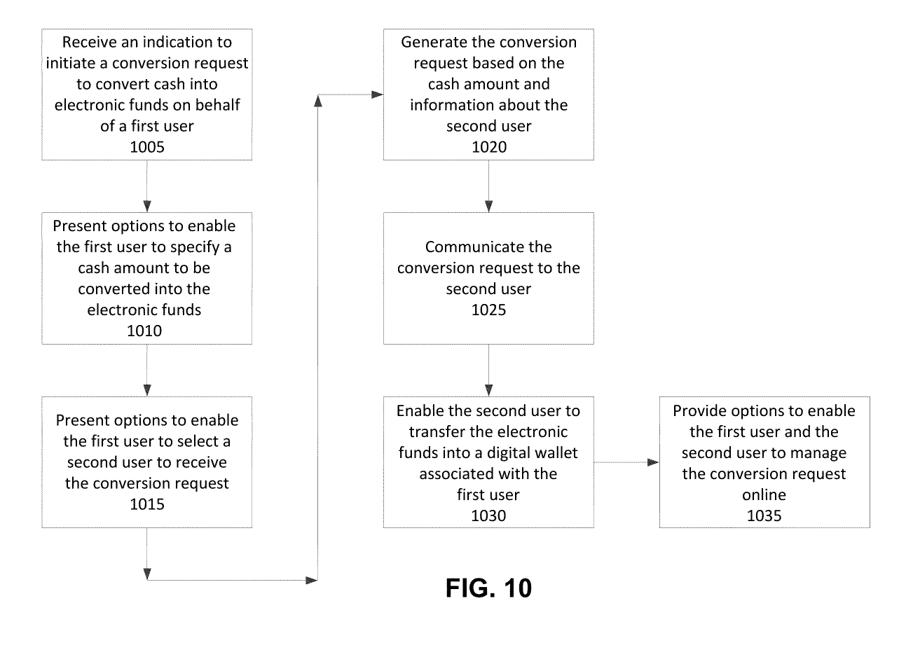

Turning to FIG. 10, an example flow diagram of a cash-to-electronic funds conversion process is shown. The cash-to-electronic funds conversion process may be based on a user who has cash and wants to convert the cash into the electronic funds. The user may not have a credit card or a financial account to fund a digital wallet to make online purchase or payment. The process may begin at block 1005 based on receiving information that a first user wants to initiate a cash conversion operation with a second user. At block 1010, the first user is enabled to specify an amount of cash to be converted into the electronic funds. At block 1015, the first user is enabled to specify the identification of the second user. For example, the second user may be identified based on an email address or a contact via a social network. At block 1020, a conversion request is generated on behalf of the first user. At block 1025, the conversion request may be communicated to the second user. The communication may be via email and/or posting on a social network. At block 1030, the second user may be enabled to transfer the electronic funds into a digital wallet of the first user. At block 1035, options may be presented to enable the first and/or the second user to manage the conversion request so that the second user is fully reimbursed for the transfer of the electronic funds in an equivalent cash amount.

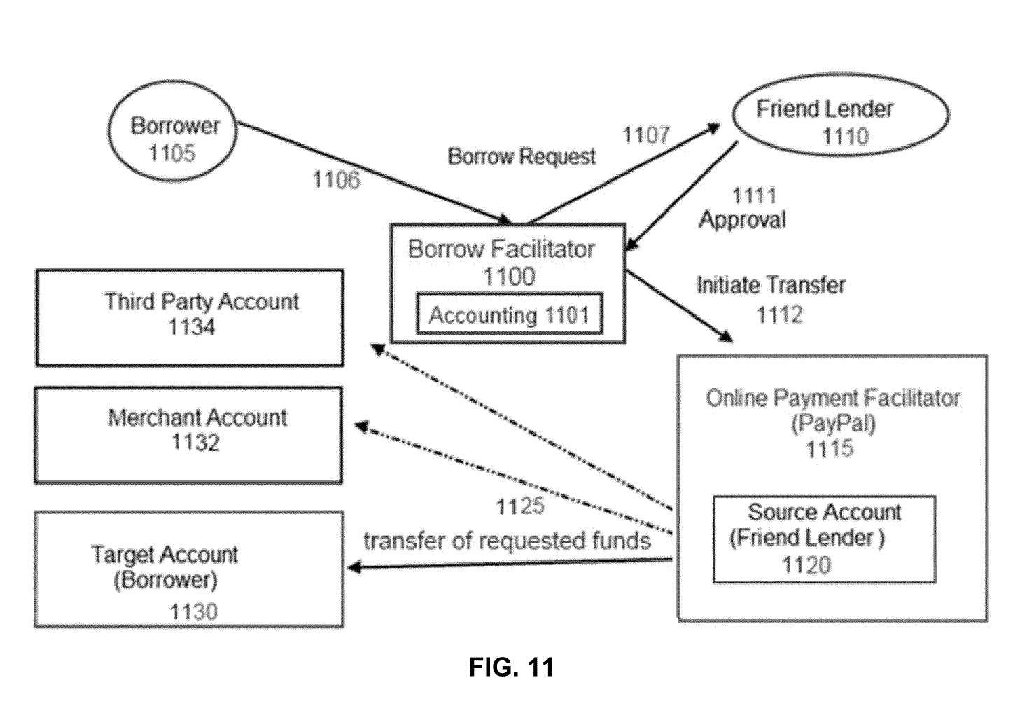

Turning to FIG. 11, example payment diagrams using a borrow facilitator is shown. A borrow facilitator 1100 may receive information 1106 from a borrower 1105 to generate a borrow request 1107. The borrow request 1107 may be distributed to a friend lender 1110. The friend lender 1110 may respond with an approval 1111 (or an indication that the friend lender 1110 is going to lend the requested electronic funds). The borrow facilitator 1100 may initiate a fund transfer request 1112 to an entity 1115 that holds the funds of the friend lender 1110. The entity 1015 may be a financial institution or a digital wallet service provider such as, for example, PayPal. The fund transfer request 1112 may be processed by the entity 1115 causing the requested funds 1125 to be transferred from a source financial account 1120 of the friend lender to a target financial account 1130 of the borrower. For some embodiments, the transfer of the requested funds may be from the source financial account 1120 to a financial account 1132 associated with an online merchant or service provider. For some embodiment, the transfer may be from the source financial account 1120 to a financial account 1134 associated with a third party on behalf of the borrower 1105. By transferring to the financial accounts 1132 or 1134, the pending payment process may be completed sooner comparing to transferring to the target financial account 1130.

For some embodiments, the borrow facilitator 1100 may include an accounting module 1101 configured to enable the borrower 1105 and the friend lender 1110 to manage the borrow requests and any active loans between them. The accounting module 1101 may be configured to provide options to enable the borrower 1105 and the friend lender 1110 to review information about active loan transactions, payment information, balance information, etc. For some embodiments, the accounting module 1101 may be configured to enable the friend lender 1110 to upload proof or evidence showing that the electronic funds has been transferred from a financial account of the friend lender 1110 to a financial account of the borrower 1105. For example, the friend lender 1110 may upload a copy of the borrow request received from the borrow facilitator 1100 on behalf of the borrower 1105, a copy of the transfer invoice (e.g., PayPal transfer receipt) showing the transfer of the electronic funds from the friend lender's financial account 1120 to the borrower's financial account 1130 or to a third party financial account 1132 or 1134 associated with the borrower 1105. Other types of proof or evidence such as email messages regarding the existence of the loan between the borrower 1105 and the friend lender 1110 may also be uploaded. Similarly, the borrower 1105 may upload proof or evidence of payments made to the friend lender 1110. This may include copy of payment invoice (e.g., PayPal transfer receipt), copy of checks, or any communication from the friend lender 1110 confirming receipt of payments from the borrower 1105. For some embodiments, the accounting module 1101 may also be configured to store information associated with the financial account of the borrowers and the friend lenders. For example, the accounting module 1101 may store the email address that the borrowers and the lenders used to register with PayPal.

For some embodiments, the borrow facilitator 1100 may be authorized to receive proofs of electronic funds transfer from the friend lender 1110 to the borrower 1105 from the financial institution (e.g., digital wallet service provider) 1115. For example, the friend lender 1110 may authorize the borrow facilitator 1100 to receive a copy of an invoice showing the transfer of the requested electronic funds from the digital wallet 1120 of the friend lender 1110 to the digital wallet 1130 of the borrower 1105. Similarly, the borrower 1105 may authorize the borrow facilitator 1100 to receive a copy of an invoice showing a payment made by the borrower 1105 to the friend lender 1110. The documents uploaded by the borrower 1105 and the friend lender 1110 (or received by the borrow facilitator 1100) may then be associated with the borrow request and maintained in a database (e.g., accounting database 1255 shown in FIG. 12) associated with the borrow facilitator 1100. The borrower 1105 and the friend lender 1110 may be associated with the same digital wallet service provider (e.g., PayPal). It may be possible that the borrower 1105 is associated with one digital wallet service provider while the friend lender is associated with a different digital wallet service provider.

The accounting module 1101 may be configured to send reminder notices to the borrower 1105 and/or the friend lender 1110 periodically. The frequency of the notification may be configured by the friend lender 1110 and/or the borrower 1105. The information maintained by the accounting module 1101 may be used as proofs to resolve any possible dispute between the borrower 1105 and the friend lender 1110.

For some embodiments, the accounting module 1101 may be configured to keep track of the borrow requests generated on behalf of a borrower even though some of the borrow requests may not result in actual loans. The proofs and/or evidences uploaded by the borrower 1105 and the friend lender 1110 and the information maintained by the borrow facilitator 1100 may be viewed by the borrower 1105 and the friend lender 1110 via a user interface associated with the accounting module 1101.

For some embodiments, the accounting module 1101 may be configured to manage loans that are established without using the borrow facilitator 1100. For example, an existing loan established offline between a borrower and a friend lender may be imported and managed using the user interface associated with the accounting module 1101.

The borrow facilitator 1100 may be configured to enable the transfer of the requested electronic funds to be between a source account of one type and a target account of a different type or of the same type. For example, the transfer may be from one PayPal account to another PayPal account, from a PayPal account to a bank account, from a bank account to a PayPal account, from a credit card or debit account to a PayPal account, from a PayPal account to an account of a merchant or a service provider, etc. For some embodiments, the transfer of the electronic funds may be from a source financial account to a destination financial account associated with the borrow facilitator 1100. For example, the borrow facilitator 1100 may be configured to operate as a financial institution and enable its users to have own financial accounts to transfer and receive the electronic funds.

For some embodiments, the accounting module 1101 may be configured to analyze a borrower's loan accounts to reconcile various active loans and provide a loan consolidation recommendation to the borrower 1105. For some embodiments, the recommendation may be related to redirecting a loan owed to a first friend lender from the first friend lender to a second friend lender. It may be noted that there may be multiple levels of redirection including, for example, a redirection where an amount (e.g., $30.00) user “A” owes to user “B” may be redirected in smaller amounts to users “B” (e.g., $5.00), “C” (e.g., $20.00) and “D” ($5.00). As another example, the user “A” owes user “B” one amount of money, and the user “B” owes user “C” the same amount of money, and the redirection recommends that user “A” pays user “C” the same amount that the user “A” owes to the user “B”.

For some embodiments, the borrow facilitator 1100 may be configured to operate as a financial institution which offer accounts (referred to as a borrow facilitator account) to the friend lender 1110 and the borrower 1105. The borrow facilitator 1100 may need to be registered and its operation may need to be in compliance with various state and/or country rules and regulations. In this capacity, the requested electronic funds may be transferred from one borrow facilitator account to another borrow facilitator account, from an external account (e.g., credit card, other bank account, debit card, PayPal, etc.) to a borrow facilitator account, and from a borrow facilitator account to an external account.

The borrower 1105 may use a portable or mobile computing device such as, for example, a smart phone, to use the service of the borrow facilitator 1100. The mobile computing device may include features that enable the borrower 1105 to access the Internet via a wireless router, via a cellular network, or via any other communication protocols configured for the mobile computing device. Accessing the Internet may include accessing the services of a website associated with the borrow facilitator 1100.

Turning to FIG. 12, an example block diagram of a borrow facilitator is shown. The borrow facilitator 1200 may include a registration module 1205 which may be configured to enable the borrowers and friend lenders to register with the borrow facilitator 1200. There may be a borrow request set up module 1210 which may be configured to enable a borrower to specify a borrow amount and borrow parameters. There may be a friend lender set up module 1215 which may be configured to enable a borrower to specify friend lenders in the social network. The friend lender set up module 1215 may enable the borrower to specify which social networks the borrower belongs to. The friend lender set up module 1215 may be configured to communicate with the social networks to identify the friends that the borrower may have set up in those social networks. The friend lender set up module 1215 may also be configured to enable the borrower to specify the friend lenders based on email contacts. For example, the borrower may import friend information from Google's mail system (Gmail), Yahoo's mail system, Microsoft's mail system, and other sources.

The friend lender selection module 1220 may be configured to enable the borrower to select which friend lenders to receive the borrow request. An example is shown in FIG. 5B. The friend lender selection module 1220 may be configured to enable the borrower to select one or more approving friend lenders. The financial institution communication module 1225 may be configured to enable the borrow facilitator to communicate with a digital wallet service provider (e.g., PayPal) or a financial institution (e.g., bank) to send the fund transfer requests. This may include setting application programming interfaces (API) that associated with the digital wallet service provider or the financial institution. The borrow requests may cause the electronic fund to be transferred from the digital wallets of one or more friend lenders to a digital wallet of the borrower.

The online transaction communication module 1230 may be configured to enable the borrow facilitator to communicate with an online merchant or service provider to enable the borrower to complete a payment transaction. The social network communication module 1235 may be configured to determine the borrower's friend information from the social networks. The accounting module 1240 may be configured to enable the borrowers and friends lenders to manage the borrow requests and any active loan transaction. Examples are shown in FIGS. 6A-6E. The accounting module 1240 may be configured to generate tax reporting documents to reflect any interest earned by the friend lenders.

For some embodiments, the accounting module 1240 may be configured to analyze and recommend possible loan redirection and/or consolidation. For some embodiments, the accounting module 1240 may be configured to perform conversion of currencies to accommodate currency differences.

The online merchant database 1242 may be configured to store information about online merchants and any online service providers that offer a payment option where the borrowers may borrow electronic funds to make payment. An example of the borrow-to-pay payment option is shown in FIG. 4A.

The financial institution (e.g., digital wallet service provider) database 1243 may be configured to store information about the different financial institutions associated with the borrowers and the friend lenders.

For some embodiments, the borrow facilitator 1200 may be configured to hold the electronic funds on behalf of the borrowers and/or friend lenders. For some embodiments, the borrow facilitator 1200 may be configured to receive payments from the borrowers on behalf of the friend lenders. The payments may be made from an account associated with the borrow facilitator 1200 to another account associated with the borrow facilitator 1200. The borrow facilitator 1200 may be configured to cause the electronic funds to be transferred from an external account associated with a financial institution into an internal account associated with the borrow facilitator 1200 and vice versa. The internal account may be associated with a borrower or a friend lender.

The electronic funds database 1245 may be configured to keep track of the electronic funds that the borrow facilitator 1200 may hold on behalf of the borrowers and/or the friend lenders. For some embodiments, the borrow facilitator 1200 may not hold any electronic funds at all, and it may merely perform the role of causing the transfer of the electronic funds from one external account to another external account based on a borrow request.

The borrow facilitator member database 1250 may be configured to store information about the borrowers and the friend lenders. For example, this may include detail profile information and information about their associated social networks. The accounting database 1255 may be configured to store information about the borrow requests and active loans associated with the borrowers and the friend lenders.

The mobile computing application synchronization module 1260 may be configured to enable any updates to an account of a borrower or a friend lender to be synchronized so the same value is reflected. For example, a borrower using a mobile computing device to set up a borrow request via a mobile application should be able to view the same information as when the borrower sets up the borrow request via the website associated with the borrow facilitator.

The marketplace module 1280 may be configured to enable the borrowers and the friend lenders to sell items to one another or to other users of the borrow facilitator 1200. For example, a borrower may offer to sell a personal item to a friend lender in exchange for reducing a loan balance. It may be noted that, although FIG. 12 includes multiple modules, the functions of one or more of these modules may be combined. Further, one or more of the modules described in FIG. 12 may be omitted, depending on the configuration of the borrow facilitator 1200

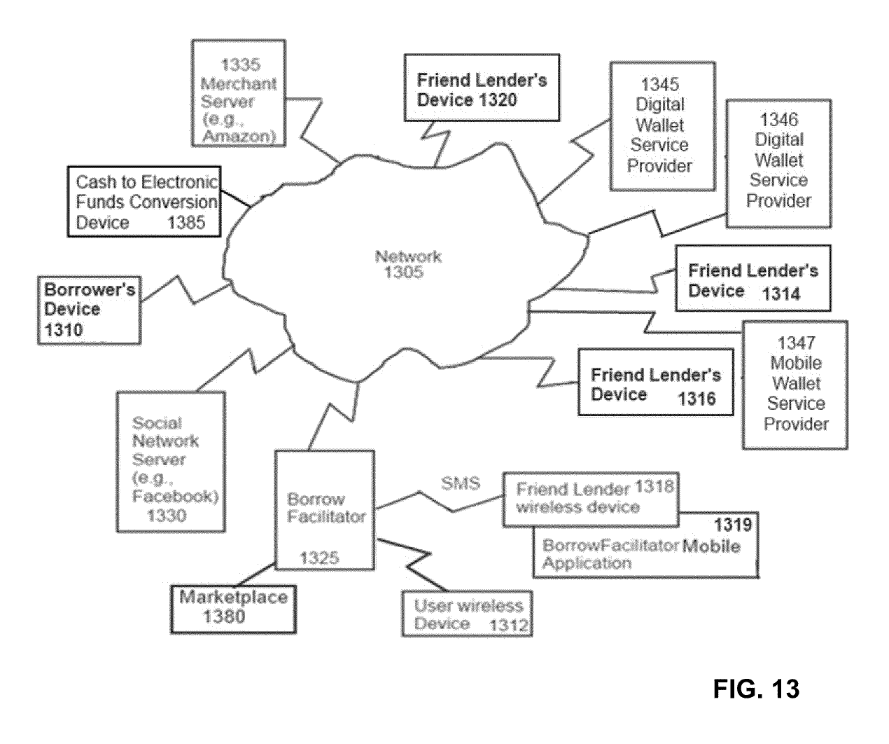

Turning to FIG. 13, an example network diagram with a borrow facilitator server is shown. There may be multiple devices (e.g., smart phone, laptop, etc.) 1310-1320 coupled to the network 1305. The devices 1310-1320 may be associated with the borrowers and/or the friend lenders. Some of these devices 1310-1320 may be wired (e.g., device 1310), while others maybe wireless (e.g., devices 1312 and 1318).

The network may be coupled with a borrow facilitator server 1325, a social network server 1330, a first digital wallet service provider server 1345 (e.g., PayPal), a second digital wallet service provider 1346, a mobile wallet service provider 1347 (e.g., Google), and a merchant server 1335. When applicable, the borrow facilitator 1325 may be communicatively coupled with one or more of the first digital wallet service provider server 1345, the second digital wallet service provider 1346, and the mobile wallet service provider 1347.

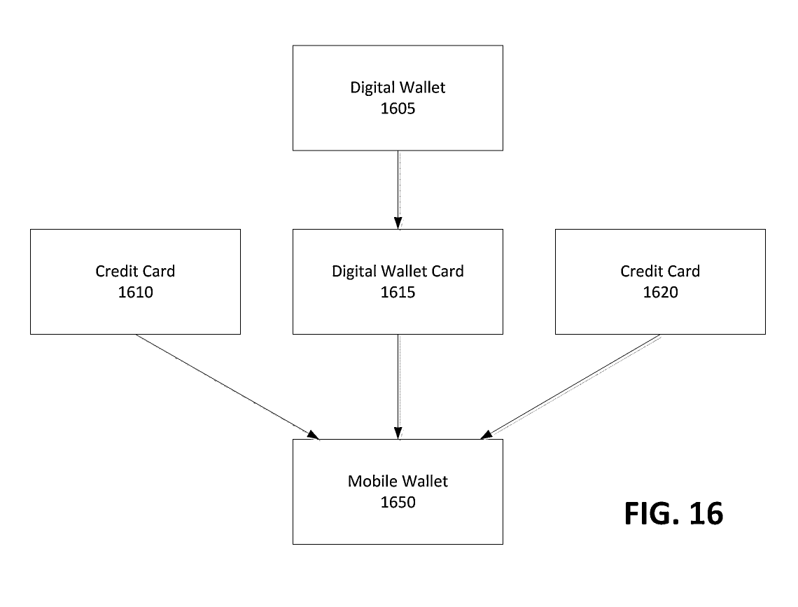

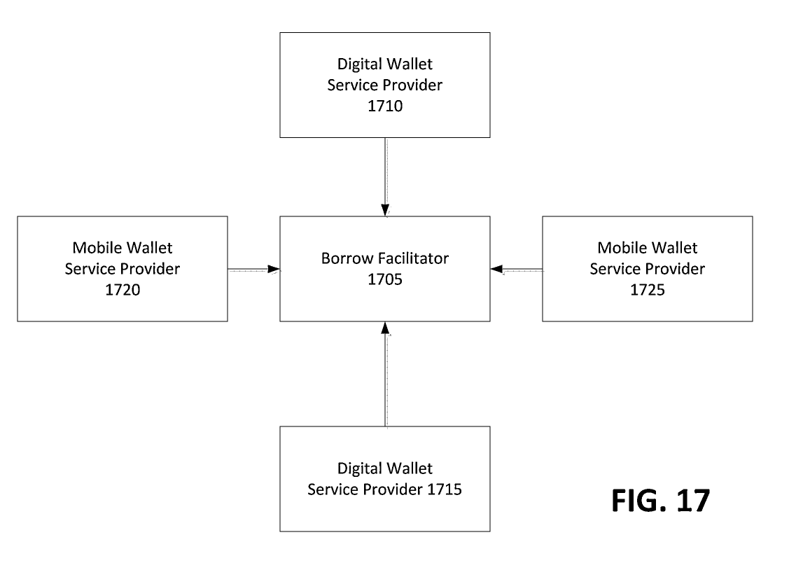

A borrower and a friend lender may be associated with the same digital wallet service provider (e.g., service provider 1345), or they each may be associated with a different digital wallet service provider. For example, the borrower may be associated with service provider 1345, while the friend lender may be associated with the digital wallet service provider 1346. The first or the second digital wallet service provider 1345 or 1346 may be associated with a mobile wallet service provider 1347, as will be described with FIGS. 16-17.

Different communication protocols may be used to enable the borrow facilitator server 1325 to communicate with the other servers and user devices 1310, 1312, 1314, and 1318. The wireless user devices 1312 and 1318 (e.g., smartphones, tablets, etc.) may communicate with the borrow facilitator server 1325 using any available cellular network and cellular communication protocol or any wireless router using wireless fidelity (Wi-Fi) associated communication protocol.

With the popularity of the wireless user devices and the electronic funds, a borrower may be able to use the wireless user devices to borrow electronic funds from another user to complete a payment with an online merchant, an online service provider, an in-store merchant or an in-store service provider. It may be possible for the borrower and the friend lenders to be physically in the same country or in different countries. It may be possible for the borrower may specify a borrow request using one monetary unit (e.g., dollar) while the friend may be willing to lend money using a different monetary unit (e.g., euro).

For some embodiments, there may be mobile applications (e.g., Android app, Apple app, etc.) 1319 associated with the borrow facilitator server 1325. The mobile applications may be downloaded to the wireless user devices 1312 and 1318. The mobile applications may have interfaces configured to make it easier for the borrowers and the friend lenders to use the services of the borrow facilitator within the confinement of the screen of the wireless user devices 1312 and 1318. A borrower may use the mobile application and the wireless user devices 1312 to initiate the borrow request. A friend lender may use the mobile application and the mobile/wireless device 1318 to approve or deny the borrow request.

For some embodiments, the borrow facilitator server 1325 may communicate with devices associated with a friend lender and a borrower using short message systems (SMS) or text messages via any SMS server. The borrow facilitator server 1325 may be configured to use email messages, automatic voice calls to communicate with the user devices associated with the friend lender and the borrower. The borrow facilitator server 1325 may be configured to post private messages on the social network walls or timeline of the friend lender and/or the borrower.

For some embodiments, the borrow facilitator server 1325 may be associated with a marketplace 1380. The marketplace 1380 may be implemented as a service of the borrow facilitator server 1325, or it may be a service offered by a third party server. The marketplace 1380 may enable the borrowers and the friend lenders to list, sell or exchange items. A sale may be in the form of an exchange with the friend lender accepting an item from the borrower and agreeing to reduce the loan balance by a certain amount. For some embodiments, when an item is sold by a borrower to a friend lender via the marketplace 1380, the value of that particular sale may be applied by the borrow facilitator 1325 to reduce the loan balance between the borrower and the friend lender. For some other embodiments, the friend lender may use the accounting module 1240 (shown in FIG. 12) to reduce a loan balance based on receiving an item from the borrower. The marketplace 1380 may include features that enable a borrower to upload an image and a value of an item that the borrower is willing to give to the friend lender in exchange for a reduction of the loan balance.

Records of the sale may be kept by the borrow facilitator server 1325 and may be associated with an active loan transaction between a borrower and a friend lender. For some embodiments, the borrower may sell items to anyone via the marketplace 1380. The borrow facilitator server 1325, via the marketplace 1380, may be configured to keep track of a borrower's sales balance in an account, compare that balance with the balance of any active loans, and suggest the user to make a payment to reduce one or more of the active loans.

For some embodiments, the borrow facilitator server 1325 may be configured to charge a service fee for enabling a borrower to borrow the electronic funds from one or more friend lenders. The service fee may be charged to the borrower, to the friend lender or partially to each. The borrow facilitator server 1325 may be configured to charge the service fee as a flat fee, based on a percentage of the borrow amount or a combination of both. For some embodiments, the service fee may be added to the borrow amount and become part of the amount that the borrower owes the friend lender. The borrow facilitator server 1325 may be configured to extract the service fee from the amount transferred from the financial account of the friend lender, prior to depositing the borrow amount into a financial account of the borrower. For example, the service fee may be collected by implementing the adaptive payment services offered by PayPal.

The borrow requests may be sent by the borrow facilitator server 1325 to the friend lenders via short text messages (SMS), emails, automatic phone calls, or any other form of communication. A clickable internet link (e.g., short/abbreviated/tiny link or a normal link) may be sent to the friend lenders. The link may redirect the friend lender to a webpage associated with the borrow facilitator server 1325. The webpage may provide the friend lender more details about the borrow request including, for example, options to approve the borrow request, deny the borrow request, or approve (or deny) with modified conditions (e.g., higher interest rate, etc.). The responses from the lender friends may then be processed by the borrow facilitator server 1325. For some embodiments, a friend lender who is willing to lend money to the borrower may then be redirected to a webpage of a digital wallet service provider (e.g., PayPal) where the friend lender may initiate an electronic funds transfer to the borrower/user.

For some embodiments, a borrower may receive multiple approvals from the friend lenders. The approvals may be presented to the borrower, and the borrower may then select one or more of the approving friend lenders. For example, a $200.00 borrow request is sent to 20 friend lenders, and 10 respond with various forms of approval: one friend lender approves the loan for the entire $500.00, three friend lenders approve the loan but with higher interest rate, four friend lenders approve the loan but with smaller amount, two friend lenders approve the loan but with shorter repayment period. The borrower may select a combination of friend lenders to get the requested electronic funds at the most favorable conditions. Based on the borrower's selection, the borrow facilitator server 1325 may be configured to form one or more fund transfer requests.

For some embodiments, the friend lenders may receive the borrow requests from various borrowers in one or more social networks. For example, a friend lender “A” may receive a borrow request from borrower “B” in the Facebook social network and a borrow request from borrower “C” also in the Facebook social network or a different social network. This process of borrowing the electronic funds from the friend lender “A” makes the friend lender “A” becomes a social lender or social banker. For example, the wireless device 1318 shown in FIG. 13 may be used by a social lender. That is, even though “A” is not a bank, a financial institution, a professional investor, a loan shark, or in the business of loaning money for a profit, “A” is available to act as an informal mini bank to lend electronic funds. Borrowing from a social lender may be easier because the social lender does not impose the same stringent requirements as the traditional lending institutions or professional investors. By using the processes described herein, more borrowing activities may take place with wider participation because the lending may be more competitive (e.g., lower interest rate), less stringent and the electronic funds may be available faster. The borrowers who have jobs but some credit history blemish due to factors they cannot control may still be able to borrow from the social lenders because they know one another as friends (e.g., via the social networks). As mentioned above, a friend lender may be a friend, a family member, someone recommended by a friend, etc.

Since it may be possible for anyone to lend money to their friends using the service of the borrow facilitator server 1325 as described above, a large community of social lenders or informal mini bankers may be formed. A social lender may be different from any other lending entities based various factors. For example, the social lender may not engage in the business of lending money professionally. The social lender may not be associated with a federal tax id assigned to a corporation formed for the purpose of lending money for a profit. The social lender may be a social network friend of the borrowers. The social lender may not lend money based on the same requirements as the entities that lend money professionally. The social lender may lend the electronic funds in any amount. The electronic funds may be transferred from a financial account associated with the social lender to a financial account associated with the borrower. The social lender may be an individual person.

By using the borrow facilitator server 1325 and its services, it may be possible to have many social lenders who occasionally lend electronic funds to their friends. The social lenders may be from anywhere in the world lending electronic funds to people they know. The loans made by the social lenders to their friends may also be referred to as social loans. Using the borrow facilitator server 1325 and friends from the social networks, it may be possible to have a borrower residing in one country requesting to borrow the electronic funds from a friend lender residing in another country.

For some embodiments, a cash-to-electronic-funds conversion device 1385 may also be coupled to the network 1305. A user may deposit cash using the cash-to-electronic funds conversion device 1385 to add that money into the user's digital wallet associated with a digital wallet service provider (e.g., PayPal). For example, the cash-to-electronic funds conversion device 1385 may be a self-service kiosk.

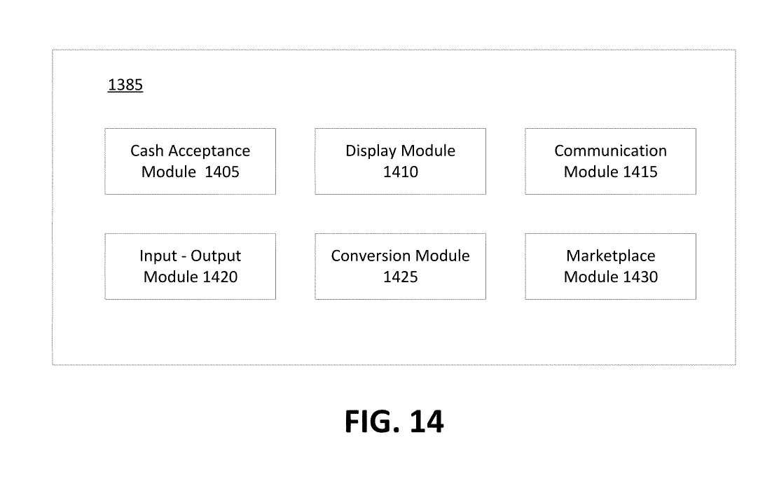

Turning to FIG. 14, an example cash-to-electronic funds conversion device is shown. It is noted that, in many areas of the world, cash may be the only form of payment, and online shopping may not be possible. The cash-to-electronic funds (CTE) conversion device 1385 may make it possible for many cash users to engage in online transactions. The CTE conversion device 1385 may be a computing device having at least display logic with a display screen, processing logic, input logic and communication logic. The CTE conversion device 1385 may be configured to enable a user to sign into a financial account (or a digital wallet associated with a digital wallet service provider) and update the balance of the account by using cash. For some embodiment, the CTE conversion device 1385 may be configured to enable a user to open a new financial account (or a digital wallet) to receive the electronic funds from the conversion.

The CTE conversion device 1385 may include a cash acceptance module 1405 configured to accept cash from a user. The cash acceptance module 1405 may be configured to accept cash in different types of currencies, detect the value of the accepted currencies, and provide the user information about the detected value. The input-output module 1420 may be configured to enable the user to provide information about the user's financial account. For example, the user may be able to register and create a new digital wallet, or the user may be able to log into an existing digital wallet. The input-output module 1420 may include an alphanumeric keypad which may be implemented as a hard keypad or a soft keypad. The input-output module 1420 may be configured to provide the user balance information and/or receipt confirming the cash amount received.

The communication module 1415 may be configured to enable establishing a connection with a digital wallet service provider (e.g., via first digital wallet service provider server 1345 shown in FIG. 13). The communication module 1415 may be configured to enable establishing a connection with an online merchant (e.g., via merchant server 1335 shown in FIG. 13). The connection may be wired or wireless.

The conversion module 1425 may be configured to convert a cash amount received via the cash acceptance module 1405 and convert it into an equivalent amount in electronic funds. The conversion module 1425 may be configured to cause the electronic funds to be deposited into the user's digital wallet. For some embodiments, the conversion module 1425 may be configured to enable the user to specify a monetary unit of the equivalent electronic funds. For example, a user depositing cash in US dollars may specify that the equivalent electronic funds to be Euros.

The display module 1410 may be configured to display information associated with the user's digital wallet and the conversion process including, for example, the amount of cash received, the equivalent electronic funds amount, the balance of the user's digital wallet. For some embodiments, the display module 1410 may be implemented to be touch-sensitive enabling the user to provide information by using the soft alphanumeric keyboard or by touch-selecting various options.

For some embodiments, the CTE conversion device 1385 may be associated with an online merchant or service provider. In this scenario, the CTE conversion device 1385 may be configured to enable the user to view information about items offered by the online merchant (e.g., via the merchant server 1335). The CTE conversion device 1385 may be configured to enable the user to purchase an item and pay for it using the user's digital wallet.

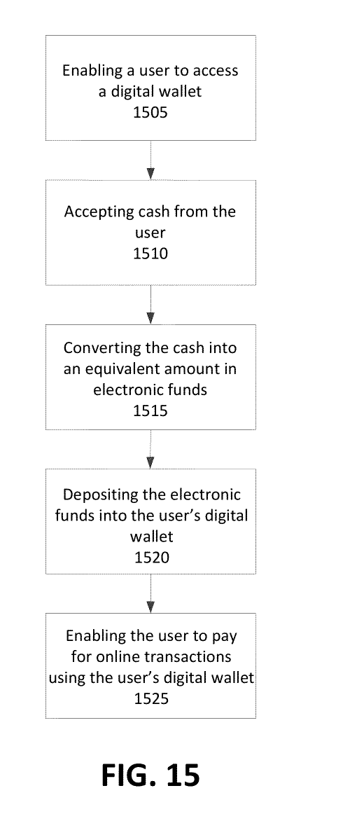

Turning to FIG. 15, an example flow diagram of a cash-to-electronic funds conversion process is shown. The conversion process may be performed based on a user wanting to use cash to purchase online items. The process may begin at block 1505 where a user may be enabled to access the user's digital wallet. The digital wallet may be associated with an existing account or a new account. At block 1510, an amount of cash may be received from the user. For example, this may be via the cash acceptance module 1405 shown in FIG. 14. At block 1515, the cash amount may be converted to an equivalent amount in electronic funds. At block 1520, the user's digital wallet is updated with the electronic funds converted from the cash amount. At block 1525, the user may be enabled to use the electronic funds to engage in transactions with an online merchant or service provider.

Turning to FIG. 16, an example block diagram of a mobile wallet is shown. As mentioned, a mobile computing device (e.g., device 110 shown in FIG. 1) may be configured with communication logic to enable short distance communication. One example of such short distance communication protocol is Near Field Communication (NFC). The mobile computing device may be configured with applications to operate as a mobile wallet 1650 (e.g., Google Wallet) and may be used to make payments with an offline or in-store merchant via a payment terminal. The mobile wallet 1650 may be linked or connected to various credit cards, debit cards, etc. For example, the mobile wallet 1650 may be linked with an American Express credit card 1610 and a Visa credit card 1620. An NFC connection with a payment terminal may be established (e.g., by tapping) to enable the payment to be made using the mobile wallet 1650.

A digital wallet 1605 may be associated with a digital wallet card 1615. The digital wallet card 1615 may be a virtual or proxy card or a physical card. For some embodiments, the mobile wallet 1650 may be coupled with the digital wallet 1605 via the digital wallet card 1615 to provide a user of the mobile wallet 1650 an alternative funding source. Information associated with the digital wallet card 1615 may be added to the mobile wallet 1650 similar to adding information about other credit cards (e.g., credit cards 1610 and 1620). A user with the mobile wallet 1650 may be able to use the electronic funds in the digital wallet 1605 via the digital wallet card 1615 to engage in online or offline transactions.

The connection of the digital wallet 1605 to the mobile wallet 1650 may be convenient and applicable in applications where control spending may be necessary. For example, instead of giving cash allowances, parents may add the allowances as electronic funds into their digital wallet 1605 and add the digital wallet card 1615 to their children's mobile computing devices (e.g., smart phones) via the mobile wallet 1650. The children may then use the mobile computing devices to make payments to merchants.

A borrower may be able to use also use the services of a borrow facilitator to fund the mobile wallet 1650. The borrower may be associated with the digital wallet 1605, the digital wallet card 1615 and the mobile wallet 1650. When the borrower does not have sufficient funds in the mobile wallet 1650, the borrower may use a smart phone application associated with the borrow facilitator to set up a borrow request to borrow the necessary electronic funds from a friend lender. An example of setting up a borrow request is shown in FIG. 4B. Based on the completion of the transfer of the electronic funds from a digital wallet of the friend lender to the digital wallet 1605, the borrower may be able to use the mobile wallet 1650 to make a payment by selecting the digital wallet card 1615 as a funding source.

It may be possible for the digital wallet service provider to also provide mobile wallet services. In this situation, the process of borrowing the electronic funds to be used in a mobile wallet may be simplified because the connection between the digital wallet 1605 and the mobile wallet 1650 may be established automatically when the accounts associated with the digital wallet 1605 is created.

As mentioned above, a mobile wallet service provider (e.g., service provider 1347 shown in FIG. 13) may enable its users to have online access to their mobile wallets. Online updates may be automatically synchronized with the mobile wallet applications on the smart phones. For example, a user may use the online access to add new credit cards into the mobile wallet, update existing credit card information, view credit card limit, etc.

The mobile wallet service provider 1347 may also enable its users to use the online access to make payments or engage in online transaction with online merchants and service providers. For some embodiments, a mobile wallet service provider may offer its users the ability to have own mobile wallet funding source to use for making payments or engage in online transaction. The mobile wallet funding source may be funded by other funding sources (e.g., credit cards, etc.) and may be viewed as an alternative funding source to the credit cards, debit cards, etc. in the mobile wallet 1650. The mobile wallet funding source may be a virtual or “proxy” card or a physical card. In this situation, the financial account described above may be an account associated with the mobile wallet funding source, and the borrow facilitator may be configured to information about the mobile wallet service provider 1347.

Turning to FIG. 17, an example block diagram of a combination of mobile wallet service providers and digital wallet service providers is shown. For some embodiments, the borrow facilitator 1705 may be associated with the mobile wallet service providers 1720 and 1725 to enable the users of the mobile wallet service providers 1720 and 1725 to borrow and lend electronic funds from one another. The electronic funds may be transferred from a mobile wallet funding source associated with a friend lender to a mobile wallet funding source associated with a borrower using, for example, the interface described in FIG. 4B and the process described in FIG. 7A. The borrower and the friend lender may be associated with the same mobile wallet service provider (e.g., service provider 1720) or with different mobile wallet service providers (e.g., service providers 1720 and 1725).

The borrow facilitator 1705 may be associated with one or more digital wallet service providers (e.g., service providers 1710 and 1715) and one or more mobile wallet service providers (e.g., service providers 1720 and 1725), it may be possible for the electronic funds to be transferred from a friend lender associated with a digital wallet service provider to a borrower associated with a mobile wallet service provider or vice versa.

Various embodiments have been described to enable a borrower to borrow the electronic funds from the friend lenders. The electronic funds may be used to complete an online transaction. Embodiments of the present invention provide many advantages because users can casually borrow the electronic funds without the stringent requirements typically imposed by the financial institutions. Embodiments of the present invention may provide methods for borrowers who have no access to credit cards or bank accounts to engage in online transactions. Embodiments of the present invention may enable the borrowers in one geographical location to borrow electronic funds from the friend lenders in different geographical locations using smart phones at any time. Other embodiments have also been described. Although embodiments of the present invention refer to real world transactions, they may also be applicable in virtual world transactions where one user borrows virtual money from another user to engage in transactions with merchants or service providers in the virtual world.

Certain aspects of embodiments of the present invention may be implemented using hardware, software, or a combination thereof and may be implemented in one or more computing devices or other processing systems. Program code may be applied to the data entered using an input device to perform the functions described and to generate output information. The output information may be applied to one or more output devices. One of ordinary skill in the art may appreciate that embodiments may be practiced with various computing device configurations, including multiprocessor systems, minicomputers, mainframe computers, and the like. Embodiments may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include at least one machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” may accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

We claim:

1. A computer-implemented method comprising:
enabling a first user to use a computing device to initiate a borrow request to borrow electronic funds from a group of one or more users;
communicating the borrow request to the group of one or more users;
enabling at least a second user from the group of one or more users to initiate a transfer of the electronic funds from a second financial account associated with the second user to a first financial account associated with the first user, the transfer of the of electronic funds forming a loan between the first user and the second user; and
enabling the first user and the second user to manage the loan online.

2. The method of claim 1, wherein enabling the first user to initiate the borrow request comprises enabling the first user to specify a set of one or more borrow parameters via a user interface, wherein the one or more borrow parameters comprises an amount of the electronic funds, and wherein the transfer of the electronic funds from the second financial account to the first financial account is based on a trusted relationship between the first user and the second user.

3. The method of claim 2, wherein the group of one or more users is selected from one or more of social network friends and email contacts of the first user.

4. The method of claim 3, wherein communicating the borrow request to the group of one or more users comprises posting a social network message or sending an electronic mail.

5. The method of claim 4, further comprising:
requiring the first user to provide information associated with the first financial account; and
storing the information associated with the first financial account.

6. The method of claim 5, wherein one or more of the first financial account and the second financial account is associated a digital wallet service provider or a mobile wallet service provider.

7. The method of claim 1, wherein enabling the first user and the second user to manage the loan online comprises enabling the first user and the second user to store documents relating to the loan.

8. The method of claim 7, wherein enabling the first user and the second user to manage the loan online comprises enabling the second user to modify a loan balance based on a payment made by the first user.

9. The method of claim 1, further comprising receiving a redirection from a website associated with an online merchant or a service provider, wherein the redirection is based on the first user selecting a borrow-to-pay payment option.

10. A computer-implemented method comprising:
providing a first user a borrow-to-pay payment option to pay for an online transaction, the first user associated with a first financial account;
based on the first user selecting the borrow-to-pay payment option, enabling the first user to set up a borrow request to borrow electronic funds from a second user, the electronic funds to be transferred from a second financial account associated with the second user into the first financial account; and
enabling the first user to pay for the online transaction using the electronic funds in the first financial account.

11. The method of claim 10, further comprising:
enabling the first user to select the second user from a group of one or more users; and
communicating the borrow request to the second user.

12. The method of claim 10, wherein the second user is selected from group of social network friends of the first user.

13. The method of claim 10, wherein the first financial account and the second financial account are existing accounts when the borrow request is communicated to the second user.

14. The method of claim 10, wherein one or more of the first financial account and the second financial account is associated with a digital wallet service provider or a mobile wallet service provider.

15. The method of claim 10, wherein enabling the first user to set up the borrow request to borrow electronic funds from the second user comprises redirecting the first user to a website associated with a borrow facilitator configured to enable the first user to set up the borrow request.

16. The method of claim 15, further comprising:
suspending the online transaction based on redirecting the first user to the website associated with the borrow facilitator; and
resuming the online transaction based on the electronic funds being in the first financial account.

17. A computer readable storage medium comprising a set of instructions which, if executed by a processor, cause a computer to:
enable a first user to use a computing device to initiate a borrow request to borrow electronic funds from a second user;
communicate the borrow request to the second user; and
enable the second user to initiate a transfer of the electronic funds from a second digital wallet associated with the second user to a first digital wallet associated with the first user.

18. The computer readable medium of claim 17, further comprising instructions to cause the computer to enable the first user and the second user to upload documents associated with the transfer of the electronic funds from the second digital wallet to the first digital wallet and to enable the second user to update a loan balance based on a loan repayment by the first user.

19. The computer readable medium of claim 17, wherein the first digital wallet and the second digital wallet are in existence when the borrow request is communicated to the second user, and wherein the transfer of the electronic funds from the second digital wallet to the first digital wallet is based on the second user being a friend or a family member of the first user.

20. The computer readable medium of claim 17, further comprising selecting the second user from a group of social network friends of the first user, and wherein the borrow request is communicated to the second user by email or by posting a private social network message.
